(19) United States
(12) Patent Application Publication
(10) Pub. No.: US 2026/0179634 A1
(43) Pub. Date: Jun. 25, 2026

(54) INFORMATION PROCESSING DEVICE, METHOD, PROGRAM, AND SYSTEM

(71) Applicant: Sony Group Corporation, Tokyo (JP)

(72) Inventors: Shinpei TSUCHIYA, Tokyo (JP); Kyosuke MATSUMOTO, Tokyo (JP); Kenichi MAKINO, Tokyo (JP)

(73) Assignee: Sony Group Corporation, Tokyo (JP)

(21) Appl. No.: 19/129,684

(22) PCT Filed: Nov. 14, 2023
(86) PCT No.: PCT/JP2023/040840

§ 371 Date: May 14, 2025

(30) Foreign Application Priority Data
Mar. 31, 2023 (JP) 2023-059340

(51) Int. Cl. G10L 21/0208; G10L 15/22; G10L 15/26

(52) U.S. Cl. CPC G10L 21/0208; G10L 15/22; G10L 15/26

(57) ABSTRACT

An information processing device will be worn and used by a first user, the device including an output unit that outputs a sound in which a voice of the first user is suppressed from an ambient sound including a voice of the first user and a voice of a second user different from the first user on a basis of a detection result from detection of an utterance of the first user.

### TECHNICAL FIELD

The present disclosure relates to an information processing device, a method, a program, and a system.

### BACKGROUND ART

With respect to a device having a hearing aid function (hereinafter also referred to as a “hearing aid device”), for example, PTL 1 discloses a technology for separating a sound signal and a non-sound signal.

### CITATION LIST

### Patent Literature

PTL 1: Japanese Laid-open Patent Publication No. 2020-25250

### SUMMARY OF INVENTION

### Technical Problem

In a hearing aid device having a hearing aid function such as a hearing aid or a sound collector, ambient sound is collected and is output to a user after hearing aid processing is performed. Since information processing including the hearing aid processing is performed, a device such as a hearing aid device is also referred to as an information processing device. When the user is speaking, the user's voice is also collected and output from the information processing device. If there is a delay between the sound collection and the sound output, there arises a problem that the user can hear his/her own voice doubly or can hear the voice mixed with the voice of the conversation partner. One of countermeasures is to suppress the user's voice output by the information processing device.

One aspect of the present disclosure suppresses a user's voice output by an information processing device.

### Solution to Problem

According to one aspect of the present disclosure, an information processing device will be worn and used by a first user, the information processing device includes: an output unit that outputs a sound in which a voice of the first user is suppressed from an ambient sound including the voice of the first user and a voice of a second user different from the first user on a basis of a detection result from detection of an utterance of the first user.

According to one aspect of the present disclosure, a method includes: outputting, by an information processing device worn and used by a first user, a sound in which a voice of the first user is suppressed from an ambient sound including the voice of the first user and a voice of a second user different from the first user on a basis of a detection result from detection of an utterance of the first user.

According to one aspect of the present disclosure, a program causes a computer worn and used by a first user to execute: a process of outputting a sound in which a voice of the first user is suppressed from an ambient sound including the voice of the first user and a voice of a second user different from the first user on a basis of a detection result from detection of an utterance of the first user.

According to one aspect of the present disclosure, a system includes: an information processing device worn and used by a first user; and an external terminal that wirelessly communicates with the information processing device, wherein the external terminal collects an ambient sound including a voice of the first user and a voice of a second user different from the first user, and wirelessly transmits at least a part of the collected ambient sound to the information processing device, and the information processing device outputs a sound in which the voice of the first user is suppressed from the ambient sound on a basis of a detection result from detection of an utterance of the first user.

### BRIEF DESCRIPTION OF DRAWINGS

FIG. 1 is a diagram illustrating an example of a schematic configuration of a system according to a first embodiment.

FIG. 2 is a diagram illustrating an example of functional blocks of an external terminal and a hearing aid device.

FIG. 3 is a diagram illustrating an example of a schematic configuration of an utterance detecting unit.

FIG. 4 is a diagram illustrating an example of a VAD signal.

FIG. 5 is a diagram illustrating a modification of the system according to the first embodiment.

FIG. 6 is a diagram illustrating an example of a schematic configuration of a system according to a second embodiment.

FIG. 7 is a diagram illustrating an example of a schematic configuration of an own sound component determining unit.

FIG. 8 is a diagram illustrating an example of determination based on correlation values.

FIG. 9 is a diagram illustrating an example of a schematic configuration of a system according to a third embodiment.

FIG. 10 is a diagram illustrating an example of a schematic configuration of the system according to the third embodiment.

FIG. 11 is a diagram illustrating an example of a schematic configuration of the system according to the third embodiment.

FIG. 12 is a diagram illustrating an example of a schematic configuration of a system according to a fourth embodiment.

FIG. 13 is a diagram illustrating an example of a schematic configuration of a system according to a fifth embodiment.

FIG. 14 is a diagram illustrating an example of a schematic configuration of the system according to the fifth embodiment.

FIG. 15 is a diagram illustrating an example of a schematic configuration of an external terminal of a system according to a sixth embodiment.

FIG. 16 is a flowchart illustrating an example of processing (method) executed in the system.

FIG. 17 is a diagram illustrating an example of a hardware configuration of a device.

FIG. 18 is a diagram illustrating a schematic configuration of the hearing aid system.

FIG. 19 is a block diagram illustrating a functional configuration of the hearing aid system.

FIG. 20 is a diagram illustrating an example of utilization of data.

FIG. 21 is a diagram illustrating an example of data.

FIG. 22 is a diagram illustrating an example of cooperation with other devices.

FIG. 23 is a diagram illustrating an example of application transition.

### DESCRIPTION OF EMBODIMENTS

Hereinafter, embodiments of the present disclosure will be described in detail with reference to the drawings. Note that in each of the following embodiments, the same elements are denoted by the same reference numerals, and redundant description will be omitted.

The present disclosure will be described according to the following order of items.
0. Introduction
1. First Embodiment
2. Second Embodiment
3. Third Embodiment
4. Fourth Embodiment
5. Fifth Embodiment
6. Sixth Embodiment
7. Method Embodiment
8. Example of Hardware Configuration
9. Examples of Hearing Aid System
10. Example of Data Utilization
11. Example of Cooperation with Other Devices
12. Example of Application Transition
13. Example Effects

### 0. Introduction

Some hearing aid devices collect ambient sound, perform hearing aid processing, and then output the sound. The output sound includes not only the voice of the conversation partner of the user but also the user's own voice. If there is a delay between the sound collection and the output, there is a problem that, for example, the user hears both his/her own voice transmitted by body conduction and his/her own voice output from the hearing aid device with a delay. There is also a problem that the own voice output with a delay is mixed with the voice of the conversation partner.

According to the disclosed technology, the user's voice output by the hearing aid device is suppressed, thereby coping with the problem caused by the above delay. In some embodiments, the user's voice is suppressed after being separated from a voice of another user (for example, a conversation partner). Note that separation of voices has not been studied in PTL 1.

In some embodiments, at least a part of the processing (such as signal processing) necessary to achieve the objective is performed, for example, on an external terminal that is communicable with the hearing aid device. Even when the processing capability on the hearing aid device is limited due to restrictions on the size, power consumption, and the like of the hearing aid device, highly functional processing and the like can be performed. A problem of delay caused by communication or each processing between the hearing aid device and the external terminal is also addressed.

### 1. First Embodiment

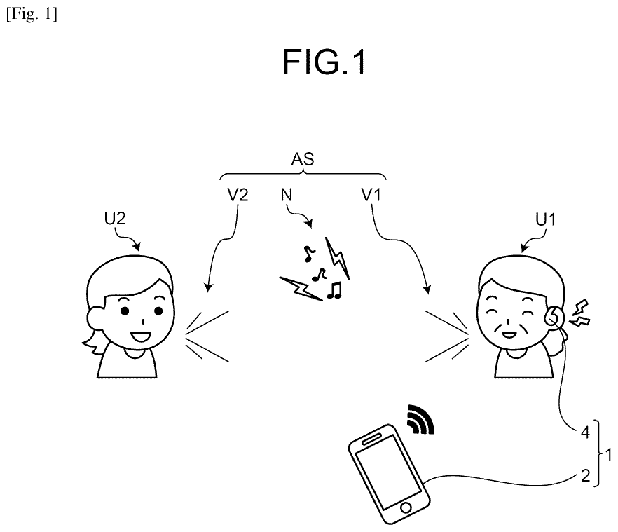

FIG. 1 is a diagram illustrating an example of a schematic configuration of a system according to a first embodiment. A main user of the system 1 is referred to as a user U1 in the drawing. FIG. 1 also illustrates a user U2 different from the user U1. The user U2 is, for example, a conversation partner of the user U1.

Various sounds are generated around the user U1. This sound is referred to as ambient sound AS in the drawing. In the example illustrated in FIG. 1, the ambient sound AS includes a voice V1, a voice V2, and a noise N. The voice V1 is a voice of the user U1. The voice V2 is a voice of the user U2. The noise N may be, for example, a generic term for various sounds unnecessary in a conversation between the user U1 and the user U2.

The system 1 assists the user U1 so that the user U1 can easily hear the voice V2 of the user U2 among the sounds included in the ambient sound AS. The system 1 can also be called a hearing assistance system or the like. The system 1 includes one or more information processing devices. The system 1 according to the first embodiment includes an external terminal 2 and a hearing aid device 4. Both the external terminal 2 and the hearing aid device 4 may be appropriately replaced with the information processing device within a range without contradiction.

The external terminal 2 is a device provided separately from the hearing aid device 4, and communicates with the hearing aid device 4. The communication may be wireless communication, and more specifically, may be short-range wireless communication using, for example, Bluetooth (BT) (registered trademark), or the like. Any terminal device capable of implementing the function of the external terminal 2 described in the present disclosure may be used as the external terminal 2. Examples of the external terminal 2 include a smartphone, a tablet terminal, a PC, and the like, and the external terminal 2 illustrated in FIG. 1 is a smartphone.

The hearing aid device 4 is used by being worn by the user U1. The hearing aid device 4 is provided in the form of, for example, an earphone, a headphone, or the like. In the example illustrated in FIG. 1, the hearing aid device 4 is an earphone worn on the ear of the user U1. The earbuds may be wireless earbuds (True Wireless Stereo (TWS)).

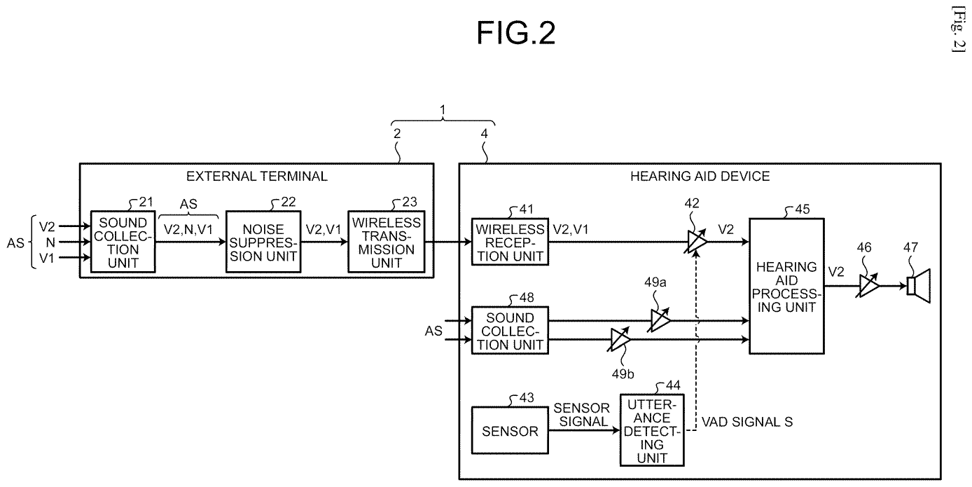

FIG. 2 is a diagram illustrating an example of functional blocks of the external terminal and the hearing aid device. The external terminal 2 includes a sound collection unit 21, a noise suppression unit 22, and a wireless transmission unit 23. The hearing aid device 4 includes a wireless reception unit 41, a volume adjusting unit 42, a sensor 43, an utterance detecting unit 44, a hearing aid processing unit 45, a volume adjusting unit 46, an output unit 47, a sound collection unit 48, and a volume adjusting unit 49.

In the external terminal 2, the sound collection unit 21 collects the ambient sound AS, converts the ambient sound AS into a signal (electric signal), and outputs the signal. The sound collection unit 21 includes one or more microphones. The number of microphones is not particularly limited, and the performance of the sound collection unit 21 is more likely to be improved as the number of microphones is larger. Note that, unless otherwise specified, a signal corresponding to the ambient sound AS is also simply referred to as the ambient sound AS. The same applies to each of the voice V2, the noise N, and the voice V1. The ambient sound AS after sound collection is sent to the noise suppression unit 22.

The noise suppression unit 22 suppresses the noise N included in the ambient sound AS from the sound collection unit 21. Various known noise suppression technologies may be used. Unless otherwise specified, it is assumed that the noise N is completely removed by the noise suppression unit 22, and the voice V2 and the voice V1 remain. The voice V2 and the voice V1 are sent to the wireless transmission unit 23.

The wireless transmission unit 23 wirelessly transmits the voice V2 and the voice V1 (which can also be said to be at least a part of the ambient sound AS) from the noise suppression unit 22 to the hearing aid device 4. For example, the BT communication described above is used for the wireless transmission.

In the hearing aid device 4, the wireless reception unit 41 wirelessly receives the ambient sound AS collected by the external terminal 2 and at least partially wirelessly transmitted, more specifically, the voice V2 and the voice V1 in this example. The received voice V2 and voice V1 are sent to the volume adjusting unit 42.

The volume adjusting unit 42 adjusts volumes (signal levels) of the voice V2 and the voice V1 from the wireless reception unit 41. The volume adjusting unit 42 includes, for example, a variable gain amplifier, and its gain is controlled on the basis of a detection signal (VAD signal) to be described later. This gain may also be simply referred to as a gain of the volume adjusting unit 42. The gain control of the volume adjusting unit 42 will be described later.

The sensor 43 is used to detect an utterance of the user U1. Examples of the sensor 43 include an acceleration sensor, a bone conduction sensor, and the like. For example, a time-series signal indicating acceleration generated according to the utterance of the user U1, a time-series signal indicating bone conduction, and the like are obtained as a sensor signal. The number of sensors 43 is not particularly limited, and the larger the number, the higher the possibility that the performance of the sensor 43 can be improved. The obtained sensor signal is sent to the utterance detecting unit 44. Furthermore, a biological sensor may be used as an example of the sensor 43.

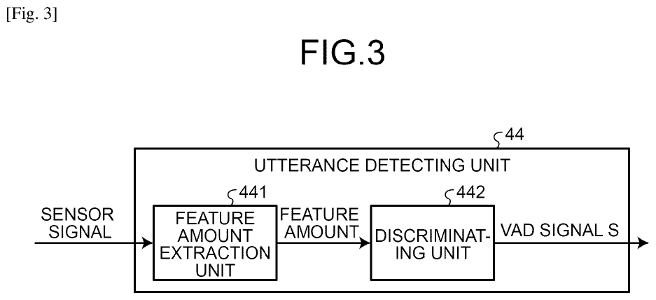

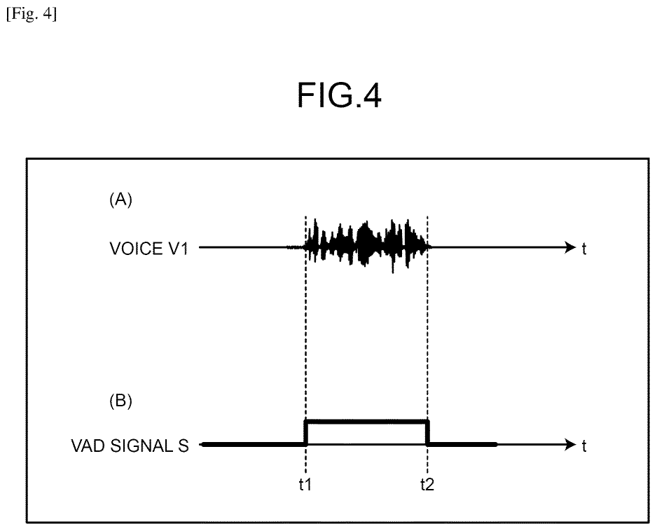

The utterance detecting unit 44 detects an utterance of the user U1 on the basis of the sensor signal from the sensor 43. The detection result of the utterance detecting unit 44 may include the presence or absence of an utterance of the user U1, and more specifically, may include an utterance section of the user U1. The detection of the utterance section is also referred to as voice section detection, that is, voice activity detection (VAD) or the like. Various known VAD technologies may be used. In one embodiment, the utterance detecting unit 44 may generate a detection signal, and the detection result of the utterance detecting unit 44 may include the detection signal. The detection signal is, for example, a signal indicating one of the presence and absence of the utterance of the user U1 at a high level and the other at a low level. Such a detection signal is also referred to as a VAD signal. This will be described with reference to FIGS. 3 and 4.

FIG. 3 is a diagram illustrating an example of a schematic configuration of the utterance detecting unit. In this example, the utterance detecting unit 44 includes a feature amount extraction unit 441 and a discriminating unit 442. The feature amount extraction unit 441 extracts a feature amount from the sensor signal (input signal). The extracted feature amounts may include feature amounts related to voice, and such feature amounts may be various known feature amounts in the field of voice technology. On the basis of the feature amount extracted by the feature amount extraction unit 441, the discriminating unit 442 determines whether the section corresponding to the sensor signal is a voice section. This voice section corresponds to a generation section of the voice V1 of the user U1, that is, an utterance section of the user U1. Note that discrimination may be understood in terms of determination, identification, and the like, and these may be appropriately read as long as there is no contradiction.

A signal based on a determination result of the discriminating unit 442, for example, a signal indicating the determination result is generated and output. An example of this signal is a VAD signal, which is referred to as a VAD signal S in the drawing. A description will be given with reference to FIG. 4.

FIG. 4 is a diagram illustrating an example of the VAD signal. (A) of FIG. 4 schematically illustrates an instantaneous value, that is, a waveform, of the voice V1 with respect to the time. (B) of FIG. 4 schematically illustrates a waveform of the VAD signal S. In this example, a period between time t1 and time t2 is a generation section of the voice V1 of the user U1, that is, an utterance section of the user U1. The VAD signal S indicates a high level only between time t1 and time t2, and indicates a low level at other times. For example, such a VAD signal S is generated as the detection result of the utterance detecting unit 44.

Returning to FIG. 2, the voice V1 of the user U1 is suppressed from the ambient sound AS on the basis of the detection result of the utterance detecting unit 44. In the first embodiment, the suppression of the voice V1 of the user U1 includes reducing the volume of the voice included in the ambient sound AS only in the utterance section of the user U1. Specifically, in the example illustrated in FIG. 2, the gain of the volume adjusting unit 42 is controlled on the basis of the VAD signal S generated by the utterance detecting unit 44. The subject that performs this control is not particularly limited, but for example, the volume adjusting unit 42 or the utterance detecting unit 44 can be the control subject.

For example, control is performed so that the gain of the volume adjusting unit 42 decreases while the VAD signal S is at the high level, that is, only in the utterance section of the user U1. Thus, the volume of the ambient sound AS is reduced. This control may be mute control for setting the gain of the volume adjusting unit 42 and the volume of the voice V1 output from the volume adjusting unit 42 to zero.

By the gain control of the volume adjusting unit 42, the voice V1 out of the voice V2 and the voice V1 from the wireless reception unit 41 is suppressed. Unless otherwise specified, it is assumed that mute control is performed and the voice V1 is completely removed, but it is not particularly limited to this example, and for example, fade processing may be performed. The volume of the voice V2 is adjusted (for example, amplified) by the volume adjusting unit 42. The voice V2 after the volume adjustment is sent to the hearing aid processing unit 45.

The hearing aid processing unit 45 executes the hearing aid processing on the voice V2 from the volume adjusting unit 42. Various types of known hearing aid processing may be performed. For example, the hearing aid processing unit 45 includes an equalizer, a compressor, and the like. By the hearing aid processing using them, the sound quality of the voice V2 is changed or noise is suppressed so that the user U1 can easily hear. The voice V2 after the hearing aid processing is sent to the volume adjusting unit 46.

The volume adjusting unit 46 adjusts (for example, amplifies) the volume of the voice V2 from the hearing aid processing unit 45. The voice V2 after the volume adjustment is sent to the output unit 47.

The output unit 47 outputs the voice V2 from the volume adjusting unit 46 to the user U1. That is, the output unit 47 outputs a sound obtained by removing the voice V1 from the ambient sound AS including the voice V1 and the voice V2 on the basis of the detection result of the utterance detecting unit 44. The user U1 can hear the voice V2 output by the output unit 47.

The sound collection unit 48 collects the ambient sound AS. The sound collection unit 48 includes, for example, one or more microphones. The collected ambient sound AS is sent to the volume adjusting unit 49. The volume adjusting unit 49 adjusts the volume of the ambient sound AS from the sound collection unit 48. In this example, the volume adjusting unit 49 includes a volume adjusting unit 49a and a volume adjusting unit 49b, and these numbers can correspond to the number of microphones of the sound collection unit 48 described above. The ambient sound AS after the volume adjustment is sent to the hearing aid processing unit 45 and output via the volume adjusting unit 46 and the output unit 47. Such processing via the sound collection unit 48, the volume adjusting unit 49, the hearing aid processing unit 45, the volume adjusting unit 46, and the output unit 47 is also referred to as normal hearing aid processing. The normal hearing aid processing may coexist with or be exclusive of the processing according to the first embodiment via the wireless reception unit 41, the volume adjusting unit 42, the hearing aid processing unit 45, the volume adjusting unit 46, and the output unit 47 described above. In the latter case, when the processing according to the first embodiment is executed, the normal hearing aid processing may be stopped (the function thereof may be turned off).

According to the first embodiment described above, in the configuration in which the ambient sound AS including the voice V1 of the user U1 is streamed and reproduced by the hearing aid device 4, the voice V1 of the user U1 output by the hearing aid device 4 can be suppressed.

Furthermore, it is also possible to cope with a problem of delay between collection and output of the voice V1 of the user U, for example, a delay caused by wireless communication between the external terminal 2 and the hearing aid device 4, processing of each unit, or the like. In other words, in a case where the voice V1 of the user U1 is not suppressed, for example, the voice V1 of the user U1 is doubly heard or mixed with the voice V2 of the user U2 due to the delay. According to the first embodiment described above, since the delayed voice V1 of the user U1 himself/herself can be suppressed (for example, muted), the user U1 can have a conversation with the user U2 without worrying about his/her voice V1.

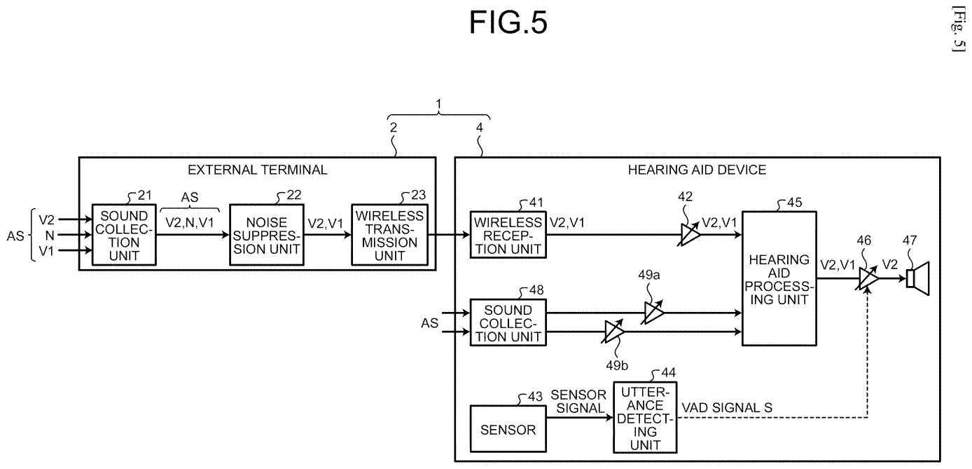

Note that, in the above description, the case where the gain of the volume adjusting unit 42 of the hearing aid device 4 is controlled in order to lower the volume of the ambient sound AS only in the utterance section of the user U1 has been described as an example. However, the gain of the volume adjusting unit 46 may be controlled instead of the volume adjusting unit 42. This will be described with reference to FIG. 5.

FIG. 5 is a diagram illustrating a modification of the system according to the first embodiment. In this example, the gain of the volume adjusting unit 46 is controlled on the basis of the VAD signal S generated by the utterance detecting unit 44. Specifically, the voice V1 and the voice V2 after the volume adjustment by the volume adjusting unit 42 are sent to the hearing aid processing unit 45. The hearing aid processing unit 45 executes the hearing aid processing on the voice V2 and the voice V1 from the volume adjusting unit 42. The voice V2 and the voice V1 after the hearing aid processing are sent to the volume adjusting unit 46.

The volume adjusting unit 46 adjusts the volume of the voice V2 and the voice V1 from the hearing aid processing unit 45. The gain of the volume adjusting unit 46 is controlled on the basis of the VAD signal S generated by the utterance detecting unit 44. By the gain control of the volume adjusting unit 46, the voice V1 out of the voice V2 and the voice V1 from the hearing aid processing unit 45 is suppressed, and the volume of the voice V2 is adjusted. The specific content of the gain control of the volume adjusting unit 46 is similar to the gain control of the volume adjusting unit 42 described above with reference to FIG. 2. The voice V2 after the volume adjustment is sent to the output unit 47. The output unit 47 outputs voice V2 from the volume adjusting unit 46. Also with such a configuration, it is possible to suppress the voice V1 of the user U1 output by the hearing aid device 4.

### 2. Second Embodiment

In the method of the first embodiment described above, in a case where the voice V1 of the user U1 and the voice of the conversation partner (for example, the voice V2 of the user U2) overlap in time series, there remains a possibility that the voice of the conversation partner is also suppressed together with the voice V1. In order to cope with this, in a second embodiment, the voice V1 of the user U1 and the voice of the conversation partner included in the ambient sound AS are separated, and the voice V1 of the user U out of the voice of the user U1 and the voice of the conversation partner which have been separated is suppressed. It is possible to reliably suppress only the voice V1 of the user U1 out of the voice of the user U1 and the voice of the conversation partner. It is more likely that more effective hearing aid can be provided.

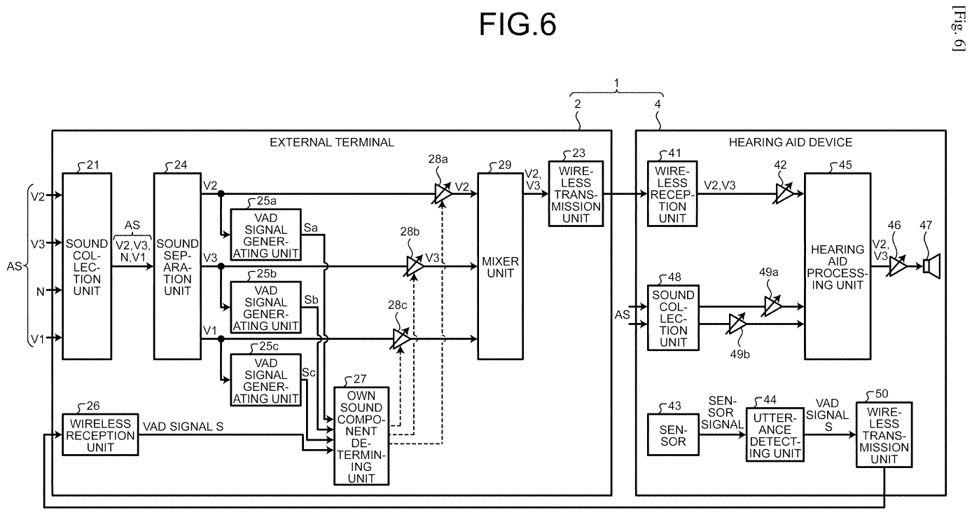

FIG. 6 is a diagram illustrating an example of a schematic configuration of a system according to the second embodiment. In this example, the ambient sound AS includes a voice V2, a voice V3, a noise N, and a voice V1. The voice V3 is a voice of a user other than the user U1 and the user U2.

The hearing aid device 4 further includes a wireless transmission unit 50. The wireless transmission unit 50 wirelessly transmits the detection result of the utterance detecting unit 44, that is, the VAD signal S in this example, to the external terminal 2 using, for example, the BT communication.

The external terminal 2 includes a sound separation unit 24 instead of the noise suppression unit 22 described above with reference to FIG. 2. The ambient sound AS collected by the sound collection unit 21 is sent to the sound separation unit 24. The external terminal 2 further includes VAD signal generating units 25, a wireless reception unit 26, an own sound component determining unit 27, a volume adjusting unit 28, and a mixer unit 29.

The sound separation unit 24 has a noise suppression function similar to that of the noise suppression unit 22 described above with reference to FIG. 2, and suppresses the noise N included in the ambient sound AS from the sound collection unit 21 (in this example, removes the noise N). Furthermore, the sound separation unit 24 separates a plurality of voices included in the ambient sound AS, in this example, the voice V2, the voice V3, and the voice V1 (speaker separating function). The voice V2, the voice V3, and the voice V1 separated by the sound separation unit 24 are sent to each of the VAD signal generating units 25 and the volume adjusting unit 28.

The VAD signal generating units 25 generate respective VAD signals corresponding to the voice V2, the voice V3, and the voice V1 from the sound separation unit 24. In order to facilitate understanding, the VAD signal generating units 25 that generate the respective VAD signals corresponding to the voice V2, the voice V3, and the voice V1 are referred to as a VAD signal generating unit 25a, a VAD signal generating unit 25b, and a VAD signal generating unit 25c in the drawing. In a case where they are not particularly distinguished, they are simply referred to as a VAD signal generating unit 25.

The VAD signal generated by the VAD signal generating unit 25a is referred to as a VAD signal Sa. The VAD signal generated by the VAD signal generating unit 25b is referred to as a VAD signal Sb. The VAD signal generated by the VAD signal generating unit 25c is referred to as a VAD signal Sc. The generated VAD signals Sa to Sc are sent to the own sound component determining unit 27.

The wireless reception unit 26 wirelessly receives the VAD signal S from the hearing aid device 4 using, for example, the BT communication. The received VAD signal S is sent to the own sound component determining unit 27.

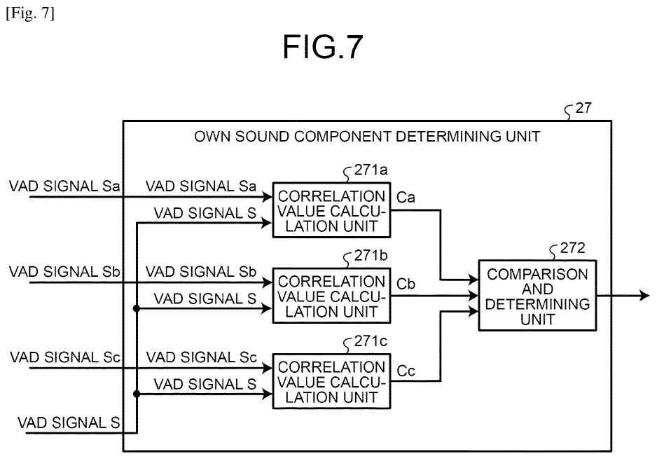

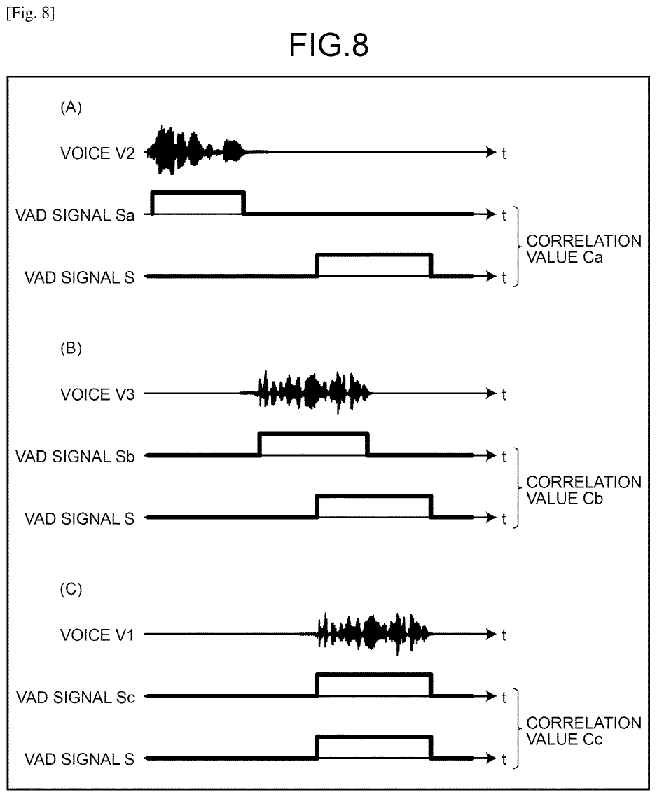

On the basis of the VAD signals Sa to Sc from the VAD signal generating units 25 and the VAD signal S from the wireless reception unit 26, the own sound component determining unit 27 determines which of the VAD signals Sa to Sc is the VAD signal corresponding to the voice V1 of the user U1. Specifically, the own sound component determining unit 27 determines that the VAD signal closest to the VAD signal S among the VAD signals Sa to Sc is the VAD signal corresponding to the voice V1 of the user U1. Whether or not the VAD signals are close to each other may be determined on the basis of, for example, whether sections in which the VAD signals indicate high levels are close to each other, and in one embodiment, determination based on a correlation value may be performed. A description will be given with reference to FIGS. 7 and 8.

FIG. 7 is a diagram illustrating an example of a schematic configuration of the own sound component determining unit. In this example, the own sound component determining unit 27 includes a correlation value calculation unit 271 and a comparison and determining unit 272.

The correlation value calculation unit 271 calculates a correlation value between each of the VAD signals Sa to Sc and the VAD signal S. The correlation value is referred to as a correlation value C, more specifically, a correlation value C between the VAD signal Sa and the VAD signal S is referred to as a correlation value Ca, a correlation value C between the VAD signal Sb and the VAD signal S is referred to as a correlation value Cb, and a correlation value C between the VAD signal Sc and the VAD signal S is referred to as a correlation value Cc. The correlation value calculation unit 271 that calculates the correlation value Ca is referred to as a correlation value calculation unit 271a in the drawing. The correlation value calculation unit 271 that calculates the correlation value Cb is referred to as a correlation value calculation unit 271b in the drawing. The correlation value calculation unit 271 that calculates the correlation value Cc is referred to as a correlation value calculation unit 271c in the drawing. In a case where they are not particularly distinguished, they are simply referred to as a correlation value calculation unit 271. The calculated correlation values Ca to Cc are sent to the comparison and determining unit 272.

On the basis of the correlation value Ca to correlation value Cc, the comparison and determining unit 272 determines which of the VAD signals Sa to Sc is the VAD signal corresponding to the voice V1 of the user U1. Specifically, the comparison and determining unit 272 determines that the VAD signal having the largest correlation value C among the VAD signals Sa to Sc is the VAD signal corresponding to the voice V1 of the user U1. A description will be given with reference to FIG. 8.

FIG. 8 is a diagram illustrating an example of determination based on the correlation values. (A) of FIG. 8 schematically illustrates waveforms of the voice V2, the VAD signal Sa corresponding to the voice V2, and the VAD signal S. (B) of FIG. 8 schematically illustrates waveforms of the voice V3, the VAD signal Sb corresponding to the voice V3, and the VAD signal S. (C) of FIG. 8 schematically illustrates waveforms of the voice V1, the VAD signal Sc corresponding to the voice V1, and the VAD signal S. As understood from the drawing, in this example, the correlation value Ca between the VAD signal Sa and the VAD signal S is the smallest, and the correlation value Cc between the VAD signal Sc and the VAD signal S is the largest. Thus, it is determined that the VAD signal Sc is the VAD signal corresponding to the voice V1 of the user U1.

Returning to FIG. 6, the volume adjusting unit 28 individually adjusts the volume (signal level) of each of the voice V2, the voice V3, and the voice V1 from the VAD signal generating units 25. The volume adjusting unit 28 that adjusts the signal level of the voice V2 is referred to as a volume adjusting unit 28a in the drawing. The volume adjusting unit 28 that adjusts the signal level of the voice V3 is referred to as a volume adjusting unit 28b in the drawing. The volume adjusting unit 28 that adjusts the signal level of the voice V1 is referred to as a volume adjusting unit 28c in the drawing. In a case where they are not particularly distinguished, they are simply referred to as a volume adjusting unit 28.

The volume adjusting unit 28 includes, for example, a variable gain amplifier, and its gain is controlled on the basis of the VAD signal to be described later. This gain may be simply referred to as a gain of the volume adjusting unit 28.

The gain of the volume adjusting unit 28 is controlled on the basis of a determination result of the own sound component determining unit 27 described above. The subject that performs this control is not particularly limited, but for example, the volume adjusting unit 28 or the own sound component determining unit 27 can be the control subject. On the basis of the determination result of the own sound component determining unit 27, the volume of each of the volume adjusting unit 28a, the volume adjusting unit 28b, and the volume adjusting unit 28c is individually adjusted so as to suppress the voice that is the source of the VAD signal closest to the VAD signal S among the voice V2, the voice V3, and the voice V1.

Specifically, among the voice V2, the voice V3, and the voice V1 separated by the previous sound separation unit 24, the gain of the volume adjusting unit 28 is controlled so that the voice having the utterance section corresponding to the utterance section of the U1 user, that is, the voice V1, is suppressed. In this example, the gain of the volume adjusting unit 28c corresponding to the voice V1 is controlled to be small. Thus, the volume of the voice V1 is reduced. This control may be mute control for setting the gain of the volume adjusting unit 28a and the volume of the voice V1 output from the volume adjusting unit 28a to zero, or may be fade control for gradually reducing the volume of the voice V1. This control may be performed while the VAD signal Sc (which may be the VAD signal S) is at the high level, that is, only in the utterance section of the user U1.

By the gain control of the volume adjusting unit 28, the voice V1 among the voice V2, the voice V3, and the voice V1 from the sound separation unit 24 is suppressed. Unless otherwise specified, it is assumed that mute control is performed and the voice V1 is completely removed. The volumes of the voice V2 and the voice V3 are adjusted (for example, amplified) by the volume adjusting unit 28a and the volume adjusting unit 28b. The voice V2 and the voice V3 after the volume adjustment are sent to the mixer unit 29.

The mixer unit 29 adds and combines the voice V2 and the voice V3 from the volume adjusting unit 28. The synthesized voice V2 and voice V3 are sent to the wireless transmission unit 23.

The wireless transmission unit 23 wirelessly transmits the voice V2 and the voice V3 from the mixer unit 29 to the hearing aid device 4 using, for example, the BT communication.

In the hearing aid device 4, the wireless reception unit 41 wirelessly receives the voice V2 and the voice V3 from the external terminal 2. The received voice V2 and voice V3 are sent to the volume adjusting unit 42.

The volume adjusting unit 42 adjusts the volumes of the voice V2 and the voice V3 from the wireless reception unit 41. In the second embodiment, the gain control of the volume adjusting unit 42 based on the VAD signal S from the utterance detecting unit 44 as in the first embodiment described above may not be performed. The volumes of the voice V2 and the voice V3 are adjusted (for example, amplified) by the volume adjusting unit 42. The voice V2 and the voice V3 after the volume adjustment are sent to the hearing aid processing unit 45.

The hearing aid processing unit 45 executes the hearing aid processing on the voice V2 and the voice V3 from the volume adjusting unit 42. The sound quality of the voice V2 and the voice V3 is changed or noise is suppressed so that the user U1 can easily hear. The voice V2 and the voice V3 after the hearing aid processing are sent to the volume adjusting unit 46.

The volume adjusting unit 46 adjusts (for example, amplifies) the volumes of the voice V2 and the voice V3 from the hearing aid processing unit 45. The voice V2 and the voice V3 after the volume adjustment are sent to the output unit 47.

The output unit 47 outputs the voice V2 and the voice V3 from the volume adjusting unit 46 to the user U1. That is, the output unit 47 outputs a sound obtained by removing the voice V1 from the ambient sound AS including the voice V1, the voice V2, and the voice V3 on the basis of the detection result of the utterance detecting unit 44. The user U1 can hear the voice V2 and the voice V3 output by the output unit 47.

Note that, when the processing according to the second embodiment described above is executed, the normal hearing aid processing, that is, processing via the sound collection unit 48, the volume adjusting unit 49, the hearing aid processing unit 45, the volume adjusting unit 46, and the output unit 47 may be stopped (the function thereof may be turned off).

Also according to the second embodiment described above, in the configuration in which the ambient sound AS including the voice V1 of the user U1 is streamed and reproduced by the hearing aid device 4, the voice V1 of the user U1 output by the hearing aid device 4 can be suppressed. Furthermore, suppression of the voice V1 of the user U1 using the VAD signal S, the VAD signal Sa, the VAD signal Sb, the VAD signal Sc, and the like enables robust processing against noise. Since the voice V1 of the user U1 is determined using the VAD signal, for example, the determination can be performed more easily than a method of learning and determining the feature amount of the voice V1 of the user U1 in advance. There is also a problem that it is difficult to specify a sound source of each separated voice only by a simple speaker separation technology, but the above method can also cope with such a problem. It is possible to provide more sophisticated hearing aid using speaker separation.

### 3. Third Embodiment

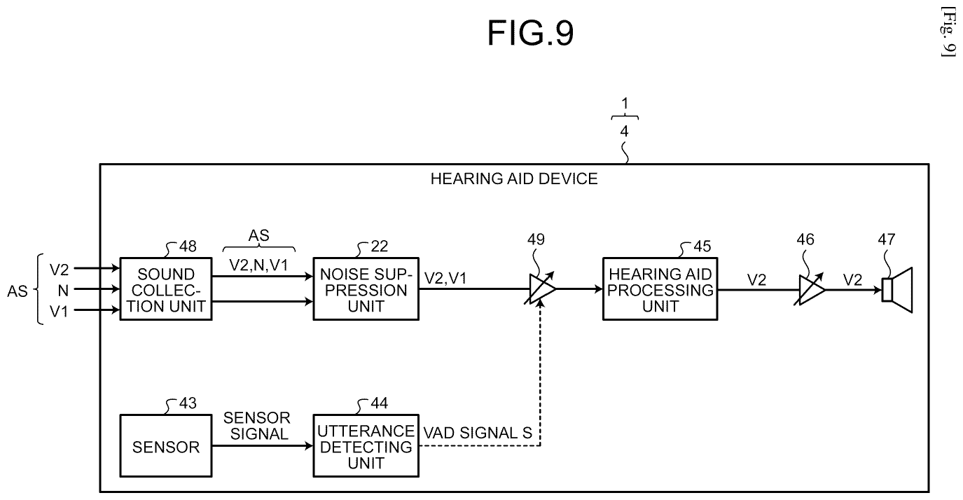

In one embodiment, the function of the system 1 described so far may be implemented by the hearing aid device 4 alone. This will be described with reference to FIGS. 9 to 11.

FIGS. 9 to 11 are diagrams illustrating an example of a schematic configuration of a system according to a third embodiment. The system 1 does not include the external terminal 2 (FIGS. 2, 5, and 6) described above but includes the hearing aid device 4.

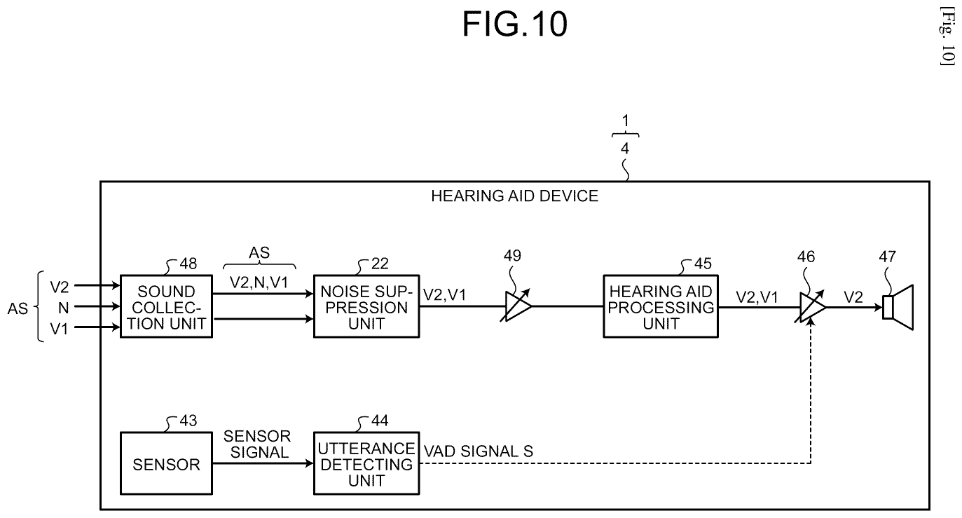

FIGS. 9 and 10 illustrate a hearing aid device 4 having a function similar to that of the system 1 (FIGS. 2 and 5) according to the first embodiment described above. In the example illustrated in FIG. 9, as compared to the configuration of FIG. 2 described above, the hearing aid device 4 is different in that it does not include the wireless reception unit 41 and the volume adjusting unit 42 but includes the noise suppression unit 22. One volume adjusting unit 49 is provided between the noise suppression unit 22 and the hearing aid processing unit 45. Among the voice V2, the noise N, and the voice V1 included in the ambient sound AS collected by the sound collection unit 48, the noise N is suppressed by the noise suppression unit 22, and the voice V2 and the voice V1 are sent to the volume adjusting unit 49.

The gain of the volume adjusting unit 49 is controlled on the basis of the VAD signal S. The specific content of the gain control is similar to the control of the volume adjusting unit 42 described above with reference to FIG. 2. The voice V1 is suppressed out of the voice V2 and the voice V1, and the voice V2 is sent to the hearing aid processing unit 45. The voice V2 after the hearing aid processing by the hearing aid processing unit 45 is output by the output unit 47 after the volume is adjusted by the volume adjusting unit 46.

In the example illustrated in FIG. 10, the gain of not the volume adjusting unit 49 but the volume adjusting unit 46 is controlled on the basis of the VAD signal S. The voice V1 is suppressed out of the voice V2 and the voice V1, and the voice V2 is sent to the output unit 47.

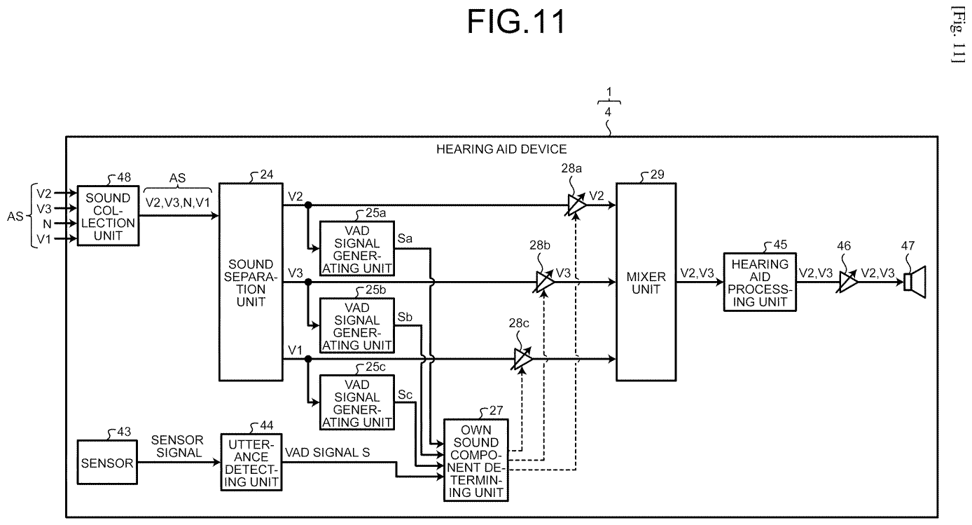

FIG. 11 illustrates the hearing aid device 4 having the function of the second embodiment described above. As compared to the configuration of FIG. 6 described above, the hearing aid device 4 is different in that it does not include the wireless reception unit 41 and the volume adjusting unit 42, but includes the sound separation unit 24, the VAD signal generating units 25, the own sound component determining unit 27, the volume adjusting unit 28, and the mixer unit 29. The VAD signal S generated by the utterance detecting unit 44 is directly sent to the own sound component determining unit 27 in the hearing aid device 4. The ambient sound AS collected by the sound collection unit 48 is sent to the sound separation unit 24.

The sound separation unit 24 suppresses the noise N among the voice V2, the voice V3, the noise N, and the voice V1 included in the ambient sound AS from the sound collection unit 48, and separates the voice V2, the voice V3, and the voice V1. Since the subsequent processing is as described above with reference to FIG. 6, the description thereof will not be repeated. The voice V2 and the voice V3 from the mixer unit 29 are sent to the hearing aid processing unit 45. The voice V2 and the voice V3 after the hearing aid processing by the hearing aid processing unit 45 are output by the output unit 47 after the volume is adjusted by the volume adjusting unit 46.

Also according to the third embodiment described above, in the configuration in which the ambient sound AS including the voice V1 of the user U1 is streamed and reproduced by the hearing aid device 4, the voice V1 of the user U1 output by the hearing aid device 4 can be suppressed. It is also possible to cope with a problem of delay between collection and output of the voice V1 of the user U, that is, a delay caused by processing of each unit in the example of the third embodiment.

### 4. Fourth Embodiment

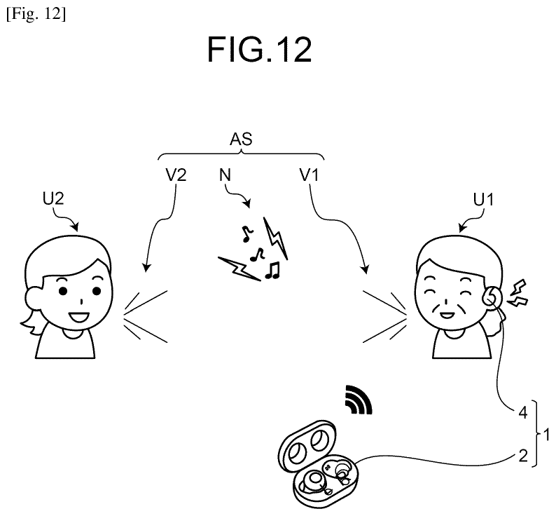

In one embodiment, the external terminal 2 may be implemented by using a case of the hearing aid device 4. This will be described with reference to FIG. 12.

FIG. 12 is a diagram illustrating an example of a schematic configuration of a system according to a fourth embodiment. In this example, the external terminal 2 is a case configured to be capable of accommodating the hearing aid device 4 and charging the hearing aid device 4. Since the hearing aid device 4 functions as a hearing aid, a sound collector, or a TWS having a hearing aid function, the external terminal 2 can also be referred to as a hearing aid case, a hearing aid charging case, or the like. In such a case, the function of the external terminal 2 described above is incorporated.

Also according to the fourth embodiment, in the configuration in which the ambient sound AS including the voice V1 of the user U1 is streamed and reproduced by the hearing aid device 4, the voice V1 of the user U1 output by the hearing aid device 4 can be suppressed. The external terminal 2 and the hearing aid device 4 are often manufactured and sold as a set. In this case, it is also possible to grasp the latency of the wireless communication between the external terminal 2 and the hearing aid device 4 in advance. As the delay is known, for example, a possibility of performing latency correction or improving correction accuracy between an utterance detection result (for example, the VAD signal S) of the user U1 in the hearing aid device 4 and each VAD (for example, the VAD signals Sa to Sc) after sound separation (speaker separation) in the external terminal 2 is increased.

### 5. Fifth Embodiment

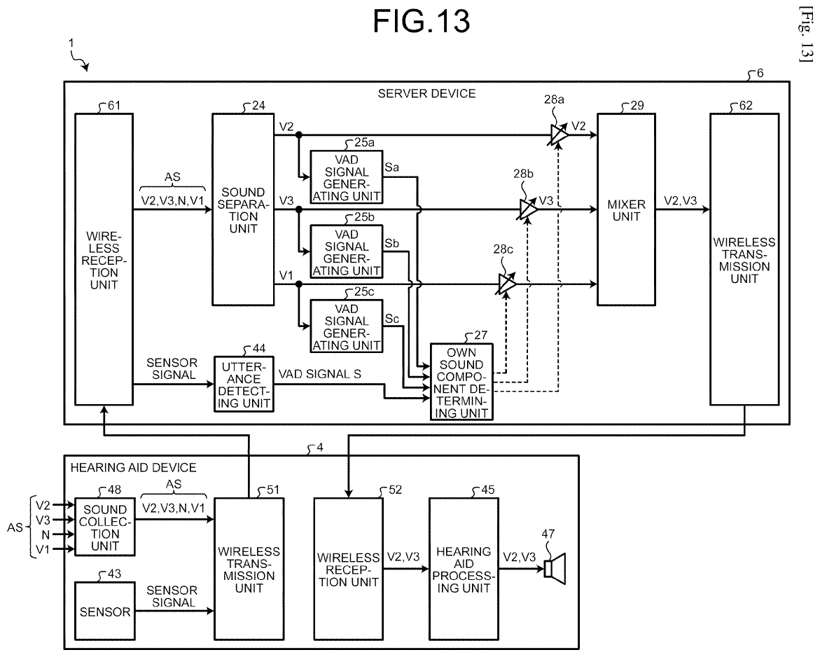

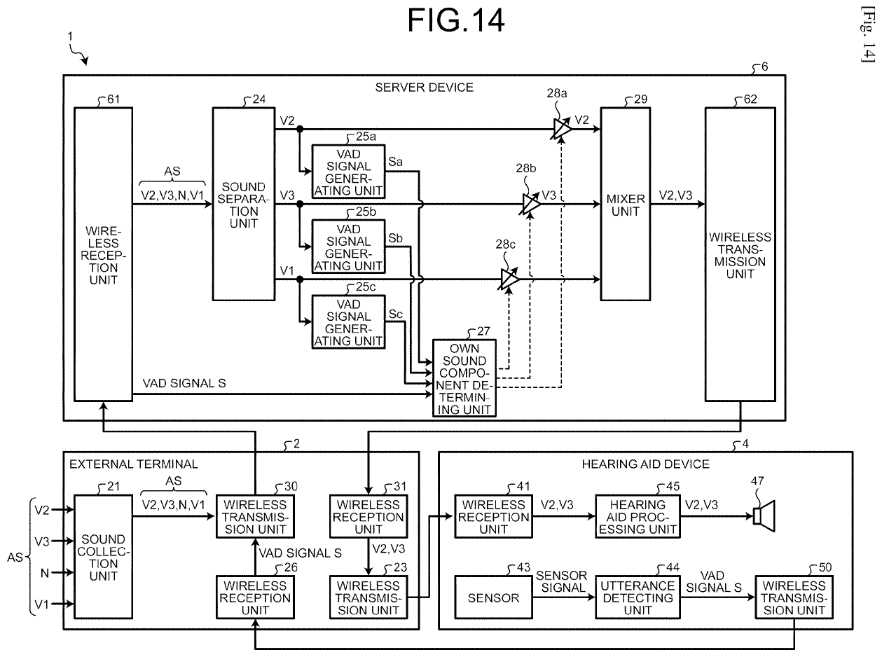

At least a part of the function of the external terminal 2 and a part of the function of the hearing aid device 4 may be provided in a device other than the external terminal 2 and the hearing aid device 4. This will be described with reference to FIGS. 13 and 14.

FIGS. 13 and 14 are diagrams illustrating an example of a schematic configuration of a system according to a fifth embodiment.

In the example illustrated in FIG. 13, the system 1 includes a hearing aid device 4 and a server device 6. The server device 6 can also be an information processing device constituting the system 1. The hearing aid device 4 and the server device 6 are configured to be capable of communicating with each other via a network such as the Internet. The functions of the sound separation unit 24, the VAD signal generating units 25, the own sound component determining unit 27, the volume adjusting unit 28, the mixer unit 29, and the utterance detecting unit 44 described above are provided in the server device 6.

The hearing aid device 4 includes the sensor 43, the sound collection unit 48, a wireless transmission unit 51, a wireless reception unit 52, the hearing aid processing unit 45, and the output unit 47. The server device 6 includes a wireless reception unit 61, the sound separation unit 24, the VAD signal generating units 25, the utterance detecting unit 44, the own sound component determining unit 27, the volume adjusting unit 28, the mixer unit 29, and a wireless transmission unit 62.

In the hearing aid device 4, the ambient sound AS is collected by the sound collection unit 48 and sent to the wireless transmission unit 51. The sensor signal acquired by the sensor 43 is also sent to the wireless transmission unit 51. The wireless transmission unit 51 wirelessly transmits the ambient sound AS from the sound collection unit 48 and the sensor signal from the sensor 43 to the server device 6.

The wireless reception unit 61 of the server device 6 wirelessly receives the ambient sound AS and the sensor signal from the hearing aid device 4. The received ambient sound AS is sent to the sound separation unit 24. The received sensor signal is sent to the utterance detecting unit 44. The utterance detecting unit 44 generates the VAD signal S on the basis of the sensor signal from the wireless reception unit 61. The generated VAD signal S is sent to the own sound component determining unit 27.

The sound separation unit 24 suppresses the noise N among the voice V2, the voice V3, the noise N, and the voice V1 included in the ambient sound AS from the wireless reception unit 61, and separates the voice V2, the voice V3, and the voice V1. Since the subsequent processing is as described above with reference to FIG. 6, the description thereof will not be repeated. The voice V2 and the voice V3 from the mixer unit 29 are sent to the wireless transmission unit 62. The wireless transmission unit 62 wirelessly transmits the voice V2 and the voice V3 to the hearing aid device 4.

The wireless reception unit 52 of the hearing aid device 4 wirelessly receives the voice V2 and the voice V3 from the server device 6. The received voice V2 and voice V3 are sent to the hearing aid processing unit 45. The hearing aid processing unit 45 executes the hearing aid processing on the voice V2 and the voice V3 from the volume adjusting unit 42. The voice V2 and the voice V3 after the hearing aid processing are sent to the output unit 47 and output by the output unit 47. Note that adjustment by the volume adjusting unit 46 as described above with reference to FIG. 6 and the like may be interposed.

Note that, in the configuration of FIG. 13, the function of the utterance detecting unit 44 may be left in the hearing aid device 4 instead of the server device 6. In this case, the VAD signal S generated by the utterance detecting unit 44 of the hearing aid device 4 is sent to the wireless transmission unit 51 and wirelessly transmitted to the server device 6.

In the example illustrated in FIG. 14, the system 1 includes the external terminal 2, the hearing aid device 4, and the server device 6. The external terminal 2 and the server device 6 are configured to be capable of communicating with each other via a network such as the Internet. The functions of the sound separation unit 24, the VAD signal generating units 25, the own sound component determining unit 27, the volume adjusting unit 28, and the mixer unit 29 described above are provided in the server device 6.

The external terminal 2 includes the sound collection unit 21, the wireless reception unit 26, a wireless transmission unit 30, a wireless reception unit 31, and the wireless transmission unit 23. The hearing aid device 4 includes the wireless reception unit 41, the hearing aid processing unit 45, the output unit 47, the sensor 43, the utterance detecting unit 44, and the wireless transmission unit 50. The server device 6 includes the wireless reception unit 61, the sound separation unit 24, the VAD signal generating units 25, the own sound component determining unit 27, the volume adjusting unit 28, the mixer unit 29, and the wireless transmission unit 62.

In the external terminal 2, the ambient sound AS is collected by the sound collection unit 21 and sent to the wireless transmission unit 30. The VAD signal S from the wireless reception unit 26 is also sent to the wireless transmission unit 30. The wireless transmission unit 30 wirelessly transmits the ambient sound AS from the sound collection unit 21 and the VAD signal S from the wireless reception unit 26 to the server device 6.

In the server device 6, the wireless reception unit 61 receives the ambient sound AS and the VAD signal S from the external terminal 2. The received ambient sound AS is sent to the sound separation unit 24. The received VAD signal S is sent to the own sound component determining unit 27.

The sound separation unit 24 suppresses the noise N among the voice V2, the voice V3, the noise N, and the voice V1 included in the ambient sound AS from the wireless reception unit 61, and separates the voice V2, the voice V3, and the voice V1. Since the subsequent processing is as described above with reference to FIG. 6, the description thereof will not be repeated. The voice V2 and the voice V3 from the mixer unit 29 are sent to the wireless transmission unit 62. The wireless transmission unit 62 wirelessly transmits the voice V2 and the voice V3 to the external terminal 2.

In the external terminal 2, the wireless reception unit 31 wirelessly receives the voice V2 and the voice V3 from the server device 6. The received voice V2 and voice V3 are sent to the wireless transmission unit 23. The wireless transmission unit 23 wirelessly transmits the voice V2 and the voice V2 from the wireless reception unit 31 to the hearing aid device 4.

In the hearing aid device 4, the wireless reception unit 41 receives the voice V2 and the voice V3 from the external terminal 2. The received voice V2 and voice V3 are sent to the hearing aid processing unit 45. The hearing aid processing unit 45 executes the hearing aid processing on the voice V2 and the voice V3 from the wireless reception unit 41. The voice V2 and the voice V3 after the hearing aid processing are sent to the output unit 47 and output by the output unit 47. Note that adjustment by the volume adjusting unit 46 as described above with reference to FIG. 6 and the like may be interposed.

Also according to the fifth embodiment described above, in the configuration in which the ambient sound AS including the voice V1 of the user U1 is streamed and reproduced by the hearing aid device 4, the voice V1 of the user U1 output by the hearing aid device 4 can be suppressed. Furthermore, since various processes are executed by the server device 6 (a device on the cloud), there is a high possibility that processes such as high-performance noise suppression and speaker separation that cannot be implemented by a local terminal (edge terminal) such as the hearing aid device 4 and the external terminal 2 can be performed. The technique of using an utterance detection result (for example, the VAD signal S) in the hearing aid device 4 makes it possible to dispose various other processing functional blocks in various regions including an edge region and a cloud region, and thereby makes it possible to achieve, for example, highly functional hearing aid, conversation, and the like.

### 6. Sixth Embodiment

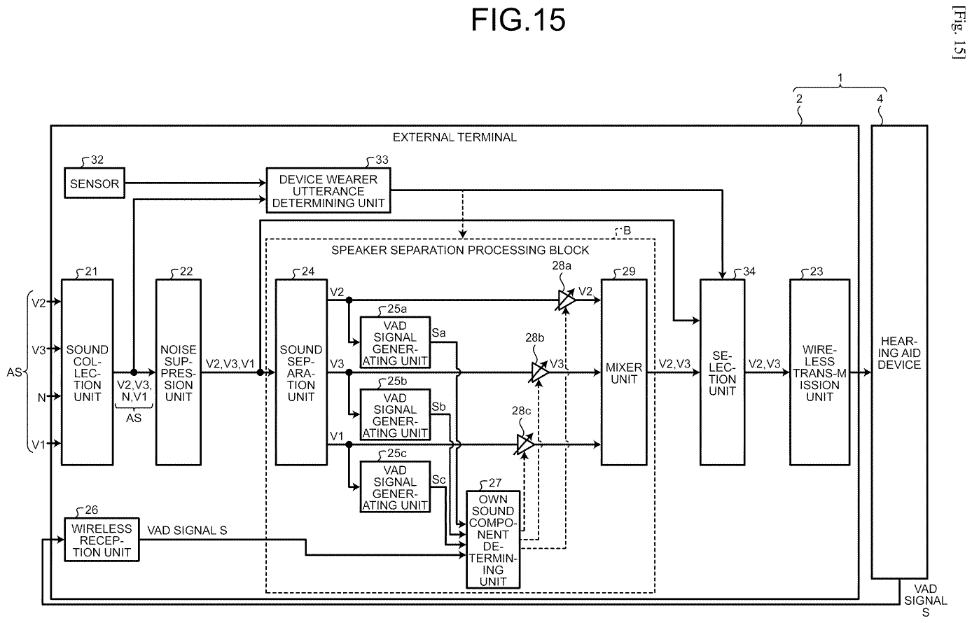

In one embodiment, the external terminal 2 may determine the utterance of the user U1 wearing the hearing aid device 4 using a sensor included in the external terminal 2 separately from the VAD signal S from the hearing aid device 4. For example, when there is no utterance of the user U1, unnecessary processing in the external terminal 2, more specifically, processing of suppressing the voice V1 of the user U1 is turned off, and the processing load can be reduced or the power consumption can be reduced. This will be described with reference to FIG. 15.

FIG. 15 is a diagram illustrating an example of a schematic configuration of an external terminal of a system according to a sixth embodiment. The hearing aid device 4 is illustrated in a simplified manner. The external terminal 2 includes the sound collection unit 21, the noise suppression unit 22, the sound separation unit 24, the VAD signal generating units 25, the wireless reception unit 26, an own sound component determining unit 27, the volume adjusting unit 28, the mixer unit 29, a sensor 32, a device wearer utterance determining unit 33, a selection unit 34, and the wireless transmission unit 23.

The ambient sound AS collected by the sound collection unit 21, in this example, the voice V2, the voice V3, the noise N, and the voice V1 are sent to the noise suppression unit 22 and the device wearer utterance determining unit 33. The noise suppression unit 22 suppresses (removes) the noise N among the voice V2, the voice V3, the noise N, and the voice V1 from the sound collection unit 21. The voice V2, the voice V3, and the voice V1 are sent to the sound separation unit 24 and the selection unit 34.

In FIG. 15, the sound separation unit 24, the VAD signal generating units 25, the own sound component determining unit 27, the volume adjusting unit 28, and the mixer unit 29 are also collectively referred to as a speaker separation processing block B. For example, by the processing of each functional block in the speaker separation processing block B, the voice V1 of the user U1 is suppressed from the ambient sound AS as described above. The voice V2 and the voice V3 from the mixer unit 29 of the speaker separation processing block B are sent to the selection unit 34.

The speaker separation processing block B can be switched between an operation state (ON) in which the processing of each functional block in the speaker separation processing block B is executed and a stop state (OFF) in which the processing is stopped. The ON and OFF of the speaker separation processing block B are controlled on the basis of a determination result of the device wearer utterance determining unit 33 described later.

The sensor 32 is used to detect an utterance of the user U1 wearing the hearing aid device 4. An example of the sensor 32 is a camera or the like, and a microphone or the like may be used together as an auxiliary. Unless otherwise specified, the sensor 32 includes a camera capable of imaging the user U1. As the sensor 32, for example, an IR sensor or a depth sensor may be used in addition to the camera described above. Imaging may be understood in a sense including imaging, and they may be appropriately read in a range without contradiction. The sensor signal acquired by the sensor 32 may be, for example, a signal of an image including the user U1. The acquired sensor signal is sent to the device wearer utterance determining unit 33.

The device wearer utterance determining unit 33 determines the presence or absence of the utterance of the user U1 on the basis of the sensor signal from the sensor 32. Various known image recognition processes and the like may be used. The speaker separation processing block B is switched between ON and OFF on the basis of a determination result. The subject that performs the switching control is not particularly limited, but for example, each functional block in the device wearer utterance determining unit 33 or the speaker separation processing block B can be the control subject.

Specifically, when there is an utterance of the user U1, for example, the speaker separation processing block B is controlled to be ON only in the utterance section thereof. In this case, the voice V2, the voice V3, and the voice V1 from the noise suppression unit 22 are sent to the selection unit 34, and the voice V2 and the voice V3 from the speaker separation processing block B are sent to the selection unit 34. On the other hand, when there is no utterance of the user U1, the speaker separation processing block B is controlled to be OFF. In this case, only the voice V2 and the voice V3 from the noise suppression unit 22 are sent to the selection unit 34.

Furthermore, the determination result of the device wearer utterance determining unit 33 is sent to the selection unit 34. The selection unit 34 selects one of the voice from the noise suppression unit 22 and the voice from the speaker separation processing block B on the basis of the determination result of the device wearer utterance determining unit 33, and sends the voice to the wireless transmission unit 23. Specifically, when there is an utterance of the user U1, the selection unit 34 selects a voice from the speaker separation processing block B, in this example, the voice V2 and the voice V3, and sends the voice to the wireless transmission unit 23. When there is no utterance of the user U1, the selection unit 34 selects the voice V2 and the voice V3 from the noise suppression unit 22 and sends them to the wireless transmission unit 23.

The wireless transmission unit 23 wirelessly transmits the voice V2 and the voice V3 from the selection unit 34 to the hearing aid device 4. As has been described above, the voice V2 and the voice V3 are output in the hearing aid device 4.

Also according to the sixth embodiment described above, in the configuration in which the ambient sound AS including the voice V1 of the user U1 is streamed and reproduced by the hearing aid device 4, the voice V1 of the user U1 output by the hearing aid device 4 can be suppressed. Furthermore, when the user U1 is speaking, the speaker separation processing block B is controlled to be OFF. Thus, it is possible to avoid the influence of voice quality deterioration and the like that may occur due to the processing in the speaker separation processing block B. Power consumption required for the processing in the speaker separation processing block B can also be reduced. It is possible to suppress power consumption and to implement higher quality audio hearing aid processing.

### 7. Method Embodiment

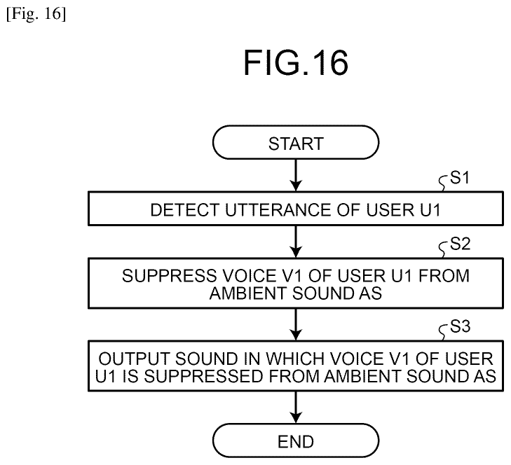

The technology described above, for example, the processing executed in the system 1 according to the first to sixth embodiments may be provided as an embodiment of a method. This will be described with reference to FIG. 16.

FIG. 16 is a flowchart illustrating an example of processing (method) executed in the system.

In step S1, an utterance of the user U1 is detected. For example, as described above, the VAD signal S indicating the utterance section of the user U1 is generated. Note that determination by the device wearer utterance determining unit 33 of the external terminal 2 in the sixth embodiment may also be included in this processing.

In step S2, the voice V1 of the user U1 is suppressed from the ambient sound AS. For example, as described above, the voice V1 of the user U1 is suppressed on the basis of the VAD signal S, and in some embodiments, on the basis of the VAD signal corresponding to each separated voice. Note that switching between ON and OFF of the speaker separation processing block B in the sixth embodiment may also be included in this processing.

In step S3, a sound in which the voice V1 of the user U1 is suppressed is output from the ambient sound AS. The output is performed, for example, via the output unit 47 of the hearing aid device 4.

### 8. Example of Hardware Configuration

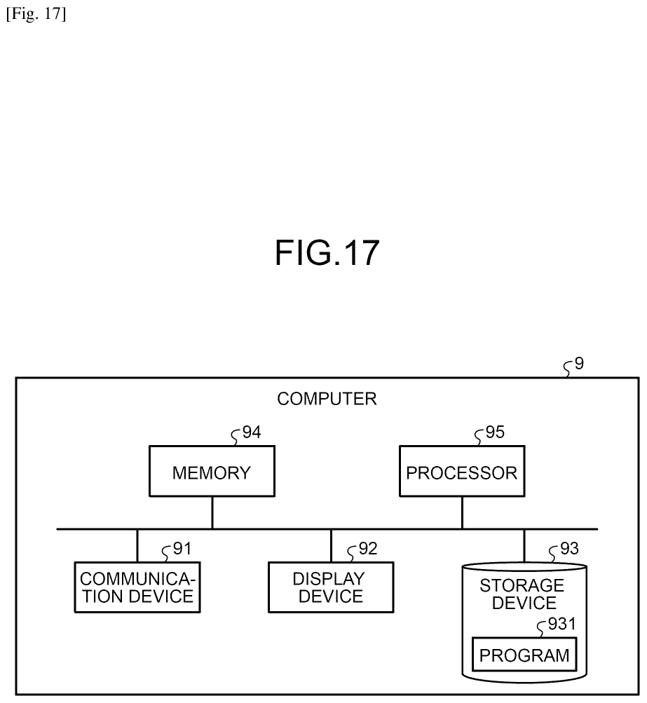

FIG. 17 is a diagram illustrating an example of a hardware configuration of a device. A device configured by including a computer 9 as illustrated functions as each device constituting the system 1 described above, for example, the external terminal 2, the hearing aid device 4, and the server device 6. As a hardware configuration of the computer 9, a communication device 91, a display device 92, a storage device 93, a memory 94, and a processor 95 connected to each other by a bus or the like are illustrated. Various elements other than the illustrated elements, for example, various sensors and the like may be incorporated in the computer 9 or combined with the computer 9 to constitute the device.

The communication device 91 is a network interface card or the like, and enables communication with other devices. The communication device 91 can correspond to the wireless reception unit 26, the wireless reception unit 31, the wireless reception unit 41, the wireless reception unit 52, the wireless reception unit 61, the wireless transmission unit 23, the wireless transmission unit 30, the wireless transmission unit 50, the wireless transmission unit 51, the wireless transmission unit 62, and the like described above. For example, in a case where the external terminal 2 is a smartphone, the display device 92 can correspond to a display unit thereof.

The storage device 93 and the memory 94 store various types of information (data and the like). Specific examples of the storage device 93 include a hard disk drive (HDD), a read only memory (ROM), and a random access memory (RAM). The memory 94 may be a part of the storage device 93. An example of the information stored in the storage device 93 is a program 931. The program 931 is a program (software) for causing the computer 9 to function as the external terminal 2, the hearing aid device 4, the server device 6, or the like.

The processor 95 executes various processes. For example, the processor 95 reads (reads out) the program 931 from the storage device 93 and develops the program in the memory 94, thereby causing the computer 9 to execute various processes executed in the external terminal 2, the hearing aid device 4, or the server device 6. As an example, the program 931 causes the computer 9 worn and used by the user U1 to execute at least a part of the processes of the respective functional blocks of the hearing aid device 4. The program 931 causes the computer 9 to execute at least a part of the processing of each functional block of the external terminal 2. The program 931 causes the computer 9 to execute at least a part of the processing of each functional block of the server device 6.

The programs 931 can be distributed collectively or separately via a network such as the Internet. Furthermore, the program 931 is collectively or separately recorded on a computer-readable recording medium such as a hard disk, a flexible disk (FD), a CD-ROM, a magneto-optical disk (MO), or a digital versatile disc (DVD), and can be executed by being read from the recording medium by the computer 9.

### 9. Examples of Hearing Aid System

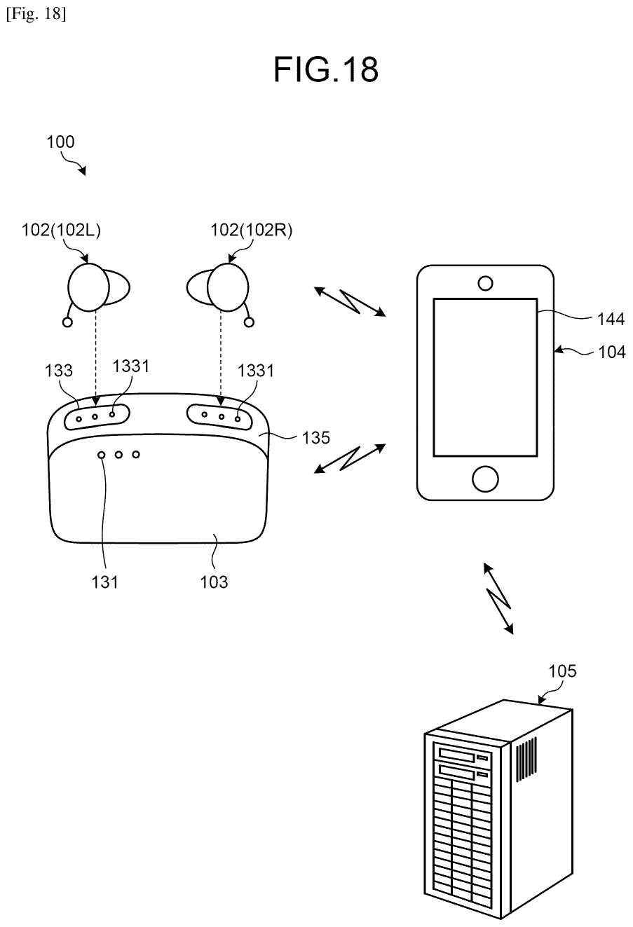

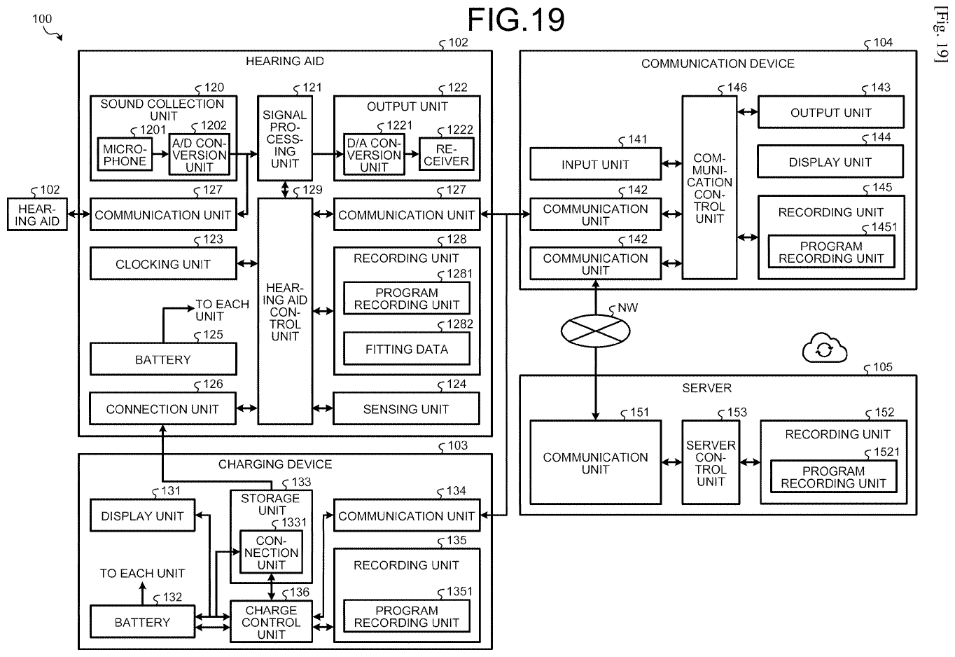

The system 1 including the hearing aid device 4 described above can also be referred to as a hearing aid system. The hearing aid system will be described with reference to FIGS. 18 and 19. Hereinafter, the hearing aid device is simply referred to as a hearing aid.

### Outline of Hearing aid System

FIG. 18 is a diagram illustrating a schematic configuration of the hearing aid system. FIG. 19 is a block diagram illustrating a functional configuration of the hearing aid system. The illustrated hearing aid system 100 includes a pair of left and right hearing aids 102, a charging device 103 (charging case) that houses the hearing aids 102 and charges the hearing aids 102, a communication device 104 such as a mobile phone capable of communicating with at least one of the hearing aids 102 or the charging device 103, and a server 105. Note that the communication device 104 and the server 105 can be used as, for example, the external terminal 2, the server device 6, and the like described above. Here, the hearing aids 102 may be, for example, sound collectors, or may be earphones, headphones, or the like having a hearing aid function. In addition, the hearing aids 102 may be configured by a single device instead of a pair of left and right devices.

Note that, in this example, a case where the hearing aids 102 are of an air conduction type will be described, but they are not limited thereto, and for example, a bone conduction type can also be applied. Furthermore, in this example, a case where the hearing aids 102 are of an ear hole type (In-The-Ear (ITE)/In-The-Canal (ITC)/Completely-In-The-Canal (CIC)/Invisible-In-The-Canal (IIC), and the like) will be described, but they are not limited thereto, and for example, an ear hook type (Behind-The-Ear (BTE)/Receiver-In-The-Canal (RIC), or the like), a headphone type, a pocket type, or the like can also be applied. Moreover, in this example, a case where the hearing aids 102 are of a binaural type will be described, but they are not limited thereto, and a single ear type to be worn on either the left or right can also be applied. In the following description, the hearing aid 102 to be worn on the right ear is referred to as a hearing aid 102R, the hearing aid 102 to be worn on the left ear is referred to as a hearing aid 102L, and when either one of the left and right is referred to, it is simply referred to as a hearing aid 102.

### Configuration of Hearing aid

The hearing aid 102 includes a sound collection unit 120, a signal processing unit 121, an output unit 122, a clocking unit 123, a sensing unit 124, a battery 125, a connection unit 126, a communication unit 127, a recording unit 128, and a hearing aid control unit 129. Note that, in the example illustrated in FIG. 19, the communication unit 127 is divided into two. Each of the communication units 127 may be two separate functional blocks or may be the same one functional block.

The sound collection unit 120 includes a microphone 1201 and an A/D conversion unit 1202. The microphone 1201 collects external sound, generates an analog sound signal (acoustic signal), and outputs the analog sound signal to the A/D conversion unit 1202. For example, the microphone 1201 functions as the sound collection unit 48 described above with reference to FIG. 2 and the like, and detects ambient sound and the like. The A/D conversion unit 1202 performs A/D conversion processing on the analog sound signal input from the microphone 1201 and outputs a digital sound signal to the signal processing unit 121. Note that the sound collection unit 120 may include both an outer (feed-forward) sound collection unit and an inner (feedback) sound collection unit, or may include either one. Furthermore, the sound collection unit 120 may include three or more sound collection units.

Under the control of the hearing aid control unit 129, the signal processing unit 121 performs predetermined signal processing on the digital sound signal input from the sound collection unit 120 and outputs the digital sound signal to the output unit 122. For example, the signal processing unit 121 functions as the hearing aid processing unit 45 described above with reference to FIG. 2 and the like. In that case, the predetermined signal processing by the signal processing unit 121 includes hearing aid processing of generating a hearing aid sound signal from the ambient sound signal. More specific examples of the signal processing include filtering processing of separating a sound signal for each predetermined frequency band, amplification processing of amplifying the sound signal with a predetermined amplification amount for each predetermined frequency band for which the filtering processing has been performed, noise reduction processing, noise canceling processing, beamforming processing, howling cancellation processing, and the like. The signal processing unit 121 includes a memory and a processor having hardware such as a digital signal processor (DSP). When the user enjoys stereophonic content using the hearing aid 102, various kinds of stereophonic processing such as rendering processing and convolution processing of a head related transfer function (HRTF) may be performed by the signal processing unit 121 or the hearing aid control unit 129. Furthermore, in a case of stereophonic content corresponding to head tracking, the head tracking processing may be performed by the signal processing unit 121 or the hearing aid control unit 129.

The output unit 122 includes a D/A conversion unit 1221 and a receiver 1222. The D/A conversion unit 1221 performs D/A conversion processing on the digital sound signal input from the signal processing unit 121 and outputs an analog sound signal to the receiver 1222. The receiver 1222 outputs an output sound (voice) corresponding to the analog sound signal input from the D/A conversion unit 1221. The receiver 1222 is configured using, for example, a speaker or the like. For example, the receiver 1222 functions as the output unit 47 described above with reference to FIG. 2 and the like, and performs output of a hearing aid sound, and the like.

The clocking unit 123 clocks the date and time and outputs the clocking result to the hearing aid control unit 129. The clocking unit 123 is configured using a timing generator, a timer having a clocking function, or the like.

The sensing unit 124 receives an activation signal for activating the hearing aid 102 and an input from various sensors to be described later, and outputs the received activation signal to the hearing aid control unit 129. For example, the sensing unit 124 functions as the sensor 43 and the utterance detecting unit 44 described above with reference to FIG. 2 and the like. The sensing unit 124 includes various sensors. Examples of the sensors include a wearing sensor, a touch sensor, a position sensor, a motion sensor, a biological sensor, and the like. Examples of the wearing sensor include an electrostatic sensor, an IR sensor, an optical sensor, and the like. Examples of the touch sensor include a push switch, a button or a touch panel (for example, an electrostatic sensor), and the like. An example of the position sensor is a global positioning system (GPS) sensor or the like. Examples of the motion sensor include an acceleration sensor, a gyro sensor, and the like. Examples of the biological sensor include a heart rate sensor, a body temperature sensor, and a blood pressure sensor, and the like. The processing contents in the signal processing unit 121 and the hearing aid control unit 129 may be changed according to the external sound collected by the sound collection unit 120 and various data sensed by the sensing unit 124 (the type of the external sound, the position information of the user, and the like). Furthermore, a wake word or the like from the user may be collected by the sensing unit 124, and voice recognition processing based on the collected wake word or the like may be performed by the signal processing unit 121 or the hearing aid control unit 129.

The battery 125 supplies power to each unit constituting the hearing aid 102. The battery 125 is configured using a rechargeable secondary battery, for example, a lithium ion battery. Note that the battery 125 may be other than the above-described lithium ion battery. For example, a zinc-air battery which has been widely used in hearing aids may be used. The battery 125 is charged by power supplied from the charging device 103 via the connection unit 126.

When the hearing aid 102 is stored in the charging device 103 to be described later, the connection unit 126 is connected to a connection unit 1331 of the charging device 103, receives power and various types of information from the charging device 103, and outputs various types of information to the charging device 103. The connection unit 126 is configured using, for example, one or more pins.

The communication unit 127 bidirectionally communicates with the charging device 103 or the communication device 104 according to a predetermined communication standard under the control of the hearing aid control unit 129. The predetermined communication standard is, for example, a communication standard such as a wireless LAN or BT. The communication unit 127 is configured using a communication module or the like. Furthermore, when communication is performed among the plurality of hearing aids 102, for example, a short-range wireless communication standard such as BT, near field magnetic induction (NFMI), or near field communication (NFC) may be used. For example, the communication unit 127 functions as the wireless reception unit 41 and the wireless transmission unit 50 described above with reference to FIGS. 2, 6, and the like.

The recording unit 128 records various types of information regarding the hearing aid 102. The recording unit 128 includes a random access memory (RAM), a read only memory (ROM), a memory card, and the like. The recording unit 128 includes a program recording unit 1281 and fitting data 1282. For example, the recording unit 128 functions as the storage device 93 described above with reference to FIG. 17 and stores various types of information.

The program recording unit 1281 records, for example, a program executed by the hearing aid 102, various kinds of data during processing of the hearing aid 102, a log at the time of use, and the like. An example of the program is the program 931 described above with reference to FIG. 17.

The fitting data 1282 includes adjustment data of various parameters of the hearing aid device used by the user, for example, a hearing aid gain for each frequency band set on the basis of a hearing measurement result (audiogram) of the user who is a patient or the like, a maximum output sound pressure, and the like. Specifically, the fitting data 1282 includes a thread shoulder ratio of the multiband compressor, ON/OFF of various signal processing for each use scene, strength setting, and the like. Furthermore, in addition to the hearing measurement result (audiogram) of the user, adjustment data or the like of various parameters included in the hearing aid device used by the user, which is set on the basis of an exchange between the user and the audiologist, a user input on an app as an alternative thereto, calibration involving measurement, or the like, may be included. Note that various parameters included in the hearing aid device may be finely adjusted through, for example, counseling with an expert or the like. Moreover, the fitting data 1282 may also include the hearing measurement result (audiogram) of the user, which is data that does not generally need to be stored in the hearing aid main body, an adjustment formula (for example, NAL-NL, DSL, and the like) used for fitting, and the like. The fitting data 1282 may be stored not only in the recording unit 128 inside the hearing aid 102 but also in the communication device 104 or the server 105. Fitting data may be stored in both the recording unit 128 inside the hearing aid 102 and the communication device 104 and the server 105. For example, by storing the fitting data in the server 105, it is possible to update the fitting data to the fitting data reflecting the user's preference, the degree of change in the user's hearing due to aging, and the like, and by downloading the fitting data to the edge device side such as the hearing aid 102, each user can always use the fitting data optimized for himself/herself, and it is expected that the user experience is further improved.

The hearing aid control unit 129 controls each unit constituting the hearing aid 102. The hearing aid control unit 129 includes a memory and a processor having hardware such as a central processing unit (CPU) and a DSP. The hearing aid control unit 129 reads and executes the program recorded in the program recording unit 1281 in the work area of the memory, and controls each component and the like through the execution of the program by the processor, so that the hardware and the software cooperate with each other to implement a functional module matching a predetermined purpose.

### Configuration of Charging Device

The charging device 103 functions as, for example, the external terminal 2 (hearing aid case) described above with reference to FIG. 12, and includes a display unit 131, a battery 132, a storage unit 133, a communication unit 134, a recording unit 135, and a charge control unit 136.

The display unit 131 displays various states related to the hearing aid 102 under the control of the charge control unit 136. For example, the display unit 131 displays information indicating that the hearing aid 102 is being charged or that charging has been completed, and information indicating that various types of information have been received from the communication device 104 or the server 105. The display unit 131 is configured using a light emitting diode (LED), a graphical user interface (GUI), and the like.

The battery 132 supplies power to each unit constituting the hearing aid 102 and the charging device 103 stored in the storage unit 133 via the connection unit 1331 provided in the storage unit 133 described later. Note that power may be supplied to the hearing aid 102 stored in the storage unit 133 and each unit constituting the charging device 103 by the battery 132 included in the charging device 103, or power may be wirelessly supplied from an external power supply, for example, as in the Qi standard (registered trademark). The battery 132 is configured using a secondary battery, for example, a lithium ion battery or the like. Note that, in this embodiment, in addition to the battery 132, a power supply circuit that supplies power to the hearing aid 102 by DC/DC conversion that converts AC power supplied from the outside into DC power and then converts the DC power into a predetermined voltage may be further provided.

The storage unit 133 individually stores the left and right hearing aids 102. Furthermore, the storage unit 133 is provided with the connection unit 1331 connectable to the connection unit 126 of the hearing aid 102.

When the hearing aid 102 is stored in the storage unit 133, the connection unit 1331 is connected to the connection unit 126 of the hearing aid 102, transmits power from the battery 132 and various types of information from the charge control unit 136, receives various types of information from the hearing aid 102, and outputs the information to the charge control unit 136. The connection unit 1331 is configured using, for example, one or more pins.

The communication unit 134 communicates with the communication device 104 according to the predetermined communication standard under the control of the charge control unit 136. The communication unit 134 is configured using a communication module. Note that power may be wirelessly supplied from the above-described external power supply to the hearing aid 102 and the charging device 103 via the communication unit 127 of the hearing aid 102 and the communication unit 134 of the charging device 103.

The recording unit 135 includes a program recording unit 1351 that records various programs executed by the charging device 103. The recording unit 135 includes a RAM, a ROM, a flash memory, a memory card, and the like. For example, after a firmware update program is acquired from the server 105 via the communication unit 134 and stored in the recording unit 135, firmware update may be performed while the hearing aid 102 is stored in the storage unit 133. Note that the firmware update may be directly performed from the server 105 via the communication unit 127 of the hearing aid 102 without via the communication unit 134 of the charging device 103. The firmware update program may be stored not in the recording unit 135 of the charging device 103 but in the recording unit 128 of the hearing aid 102.

The charge control unit 136 controls each unit constituting the charging device 103. For example, when the hearing aid 102 is stored in the storage unit 133, the charge control unit 136 supplies power from the battery 132 via the connection unit 1331. The charge control unit 136 is configured using a memory and a processor having hardware such as a CPU or a DSP. The charge control unit 136 reads and executes the program recorded in the program recording unit 1351 in the work area of the memory, and controls each component and the like through the execution of the program by the processor, so that the hardware and the software cooperate with each other to implement a functional module matching a predetermined purpose.

### Configuration of Communication Device

The communication device 104 includes an input unit 141, a communication unit 142, an output unit 143, a display unit 144, a recording unit 145, and a communication control unit 146. Note that, in the example illustrated in FIG. 19, the communication unit 142 is divided into two. Each of the communication units 142 may be two separate functional blocks or may be the same one functional block.

The input unit 141 receives inputs of various operations from the user, and outputs a signal corresponding to the received operation to the communication control unit 146. The input unit 141 includes a switch, a touch panel, and the like.

The communication unit 142 communicates with the charging device 103 or the hearing aid 102 under the control of the communication control unit 146. The communication unit 142 is configured using a communication module.

The output unit 143 outputs a sound volume of a predetermined sound pressure level for each predetermined frequency band under the control of the communication control unit 146. The output unit 143 is configured using a speaker or the like.

The display unit 144 displays various types of information regarding the communication device 104 and information regarding the hearing aid 102 under the control of the communication control unit 146. The display unit 144 includes a liquid crystal display, an organic electroluminescent display (EL display), or the like.

The recording unit 145 records various types of information regarding the communication device 104. The recording unit 145 includes a program recording unit 1451 that records various programs executed by the communication device 104. The recording unit 145 is configured using a recording medium such as a RAM, a ROM, a flash memory, or a memory card.

The communication control unit 146 controls each unit constituting the communication device 104. The communication control unit 146 includes a memory and a processor having hardware such as a CPU. The communication control unit 146 reads and executes the program recorded in the program recording unit 1451 in the work area of the memory, and controls each component and the like through the execution of the program by the processor, so that the hardware and the software cooperate with each other to implement a functional module matching a predetermined purpose.

### Configuration of Server

The server 105 includes a communication unit 151, a recording unit 152, and a server control unit 153.

The communication unit 151 communicates with the communication device 104 via the network NW under the control of the server control unit 153. The communication unit 151 is configured using a communication module. Examples of the network NW include a Wi-Fi (registered trademark) network, an Internet network, and the like.

The recording unit 152 records various types of information regarding the server 105. The recording unit 152 includes a program recording unit 1521 that records various programs executed by the server 105. The recording unit 152 is configured using a recording medium such as a RAM, a ROM, a flash memory, or a memory card.

The server control unit 153 controls each unit constituting the server 105. The server control unit 153 includes a memory and a processor having hardware such as a CPU. The server control unit 153 reads and executes the program recorded in the program recording unit 1521 in the work area of the memory, and controls each component and the like through the execution of the program by the processor, so that the hardware and the software cooperate with each other to implement a functional module matching a predetermined purpose.

### 10. Example of Data Utilization

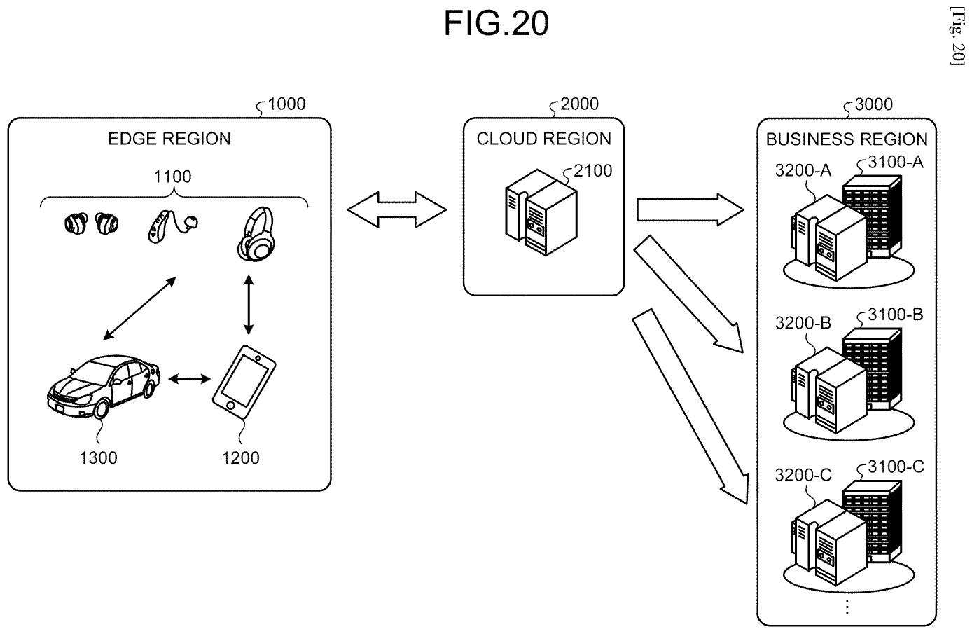

The data obtained in connection with the utilization of the hearing aid device may be utilized in various ways. An example will be described with reference to FIG. 20.

FIG. 20 is a diagram illustrating an example of utilization of data. In the illustrated system, there are an edge region 1000, a cloud region 2000, and a business region 3000. Examples of elements in the edge region 1000 include a sound producing device 1100, a peripheral device 1200, and a mobile body 1300. An example of an element in the cloud region 2000 is a server device 2100. Examples of elements in the business region 3000 include a business operator 3100 and a server device 3200.

The sound producing device 1100 in the edge region 1000 is used by being worn by the user or arranged near the user so as to emit a sound toward the user. Specific examples of the sound producing device 1100 include an earphone, a headset, a hearing aid, and the like. For example, the hearing aid device 4 described above with reference to FIG. 1 and the like may be used as the sound producing device 1100.

The peripheral device 1200 and the mobile body 1300 in the edge region 1000 are devices used together with the sound producing device 1100, and transmit a signal such as a content viewing sound and a speech sound to the sound producing device 1100, for example. The sound producing device 1100 outputs a sound corresponding to the signal from the peripheral device 1200 or the mobile body 1300 to the user. A specific example of the peripheral device 1200 is a smartphone or the like. For example, the external terminal 2 described above with reference to FIG. 1 and the like may be used as the peripheral device 1200. The mobile body 1300 is, for example, an automobile, a two-wheeled vehicle, a bicycle, a ship, an aircraft, or the like.

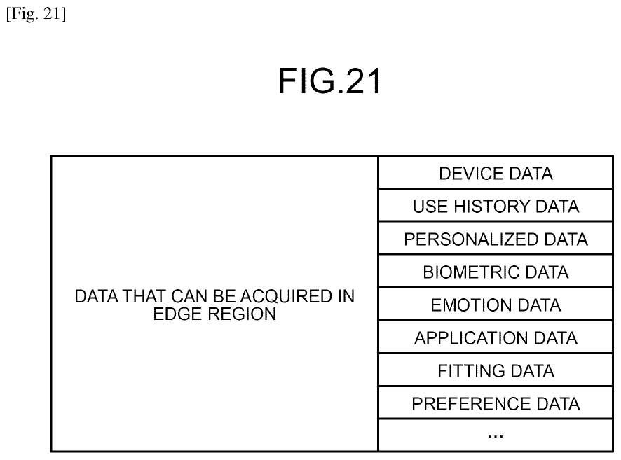

Within the edge region 1000, various data regarding utilization of the sound producing device 1100 may be obtained. A description will be given with reference to FIG. 21.

FIG. 21 is a diagram illustrating an example of data. Examples of data that can be acquired in the edge region 1000 include device data, use history data, personalized data, biometric data, emotion data, application data, fitting data, and preference data. Note that data may be understood as meaning of information, and these pieces of data may be appropriately replaced as long as there is no contradiction. Various known methods may be used to acquire the illustrated data.

The device data is data related to the sound producing device 1100, and includes, for example, type data of the sound producing device 1100, specifically, data identifying that the sound producing device 1100 is an earphone, a headphone, a TWS, a hearing aid (CIC, ITE, RIC, or the like), or the like.

The use history data is use history data of the sound producing device 1100, and includes, for example, data such as a music exposure dose, a continuous use time of a hearing aid, and a content viewing history (a viewing time and the like). Furthermore, the use history data may also include the use time, the number of uses, and the like of a function such as transmission of an utterance flag in the embodiment described above. The use history data can be used for safe listening, hearing aid of TWS, replacement notification of wax guard, and the like.

The personalized data is data related to the user of the sound producing device 1100, and includes, for example, an individual HRTF, an ear canal characteristic, a type of earwax, and the like. Data such as hearing may also be included in the personalized data.

The biometric data is biometric data of the user of the sound producing device 1100, and includes, for example, data such as perspiration, blood pressure, body temperature, blood flow, and brain waves.

The emotion data is data indicating the emotion of the user of the sound producing device 1100, and includes, for example, data indicating comfort, discomfort, or the like.

The application data is data used in various applications, and includes, for example, data of the position of the user of the sound producing device 1100 (may be the position of the sound producing device 1100), schedule, age, gender, and the like, and data of weather. For example, the position data can be useful to look for a missing sound producing device 1100 (hearing aid (HA), sound collector (personal sound amplification product (PSAP)), and the like).

The fitting data may be the fitting data 1282 described above with reference to FIG. 19, and includes, for example, data such as hearing (which may be derived from the audiogram), adjustment of sound image orientation, and beamforming. Data such as behavioral characteristics may also be included in the fitting data.

The preference data is data related to preferences of the user, and includes, for example, data such as a preference of music to listen during driving.

The above data is an example, and data other than the above data may be acquired. For example, data of a communication band, a communication status, data of a charging status of the sound producing device 1100, and the like may also be acquired. A part of the processing in the edge region 1000 may be executed by the cloud region 2000 according to the band, the communication status, the charging status, and the like. By sharing the processing, the processing load in the edge region 1000 is reduced. Since the processing load in the edge region 1000 is reduced, battery consumption can be suppressed. Furthermore, it is also possible to dynamically adjust the distribution of processing according to the processing capability of the device in the edge region 1000. For example, in a case of a device in the edge region 1000 having a low processing capability, the cloud region 2000 may be caused to share a larger amount of processing, and in a case of a device in the edge region 1000 having a high processing capability, the edge region 1000 and the cloud region 2000 may share a half of the processing.

Returning to FIG. 20, for example, data as described above is acquired in the edge region 1000 and transmitted from the sound producing device 1100, the peripheral device 1200, or the mobile body 1300 to the server device 2100 in the cloud region 2000. The server device 2100 stores (storage, accumulation, or the like) the received data.

The business operator 3100 in the business region 3000 uses the server device 3200 to acquire data from the server device 2100 in the cloud region 2000. The data can be used by the business operator 3100.

There may be various business operators 3100. Specific examples of business operators 3100 include a hearing aid store, an earphone/headphone manufacturer, a hearing aid manufacturer, a content production company, a distribution business operator or the like providing a music streaming service or the like, which are referred to as a business operator 3100-A, a business operator 3100-B, and a business operator 3100-C so that it is possible to distinguish them. The corresponding server devices 3200 are referred to as a server device 3200-A, a server device 3200-B, and a server device 3200-C in the drawing. Various data are provided to such various business operators 3100, and utilization of the data is promoted. The data provision to the business operators 3100 may be, for example, data provision by subscription, recall, or the like.

Data can also be provided from the cloud region 2000 to the edge region 1000. For example, in a case where machine learning is required to implement processing in the edge region 1000, data for feedback, revision, and the like of learning data is prepared by an administrator or the like of the server device 2100 in the cloud region 2000. The prepared data is transmitted from the server device 2100 to the sound producing device 1100, the peripheral device 1200, or the mobile body 1300 in the edge region 1000.

In a case where a specific condition is satisfied in the edge region 1000, some incentive (benefit such as premium service) may be provided to the user. An example of the condition is a condition that at least some devices of the sound producing device 1100, the peripheral device 1200, and the mobile body 1300 are devices provided by the same business operator. In a case of an incentive (electronic coupon or the like) that can be electronically supplied, the incentive may be transmitted from the server device 2100 to the sound producing device 1100, the peripheral device 1200, or the mobile body 1300.

### 11. Example of Cooperation With Other Devices

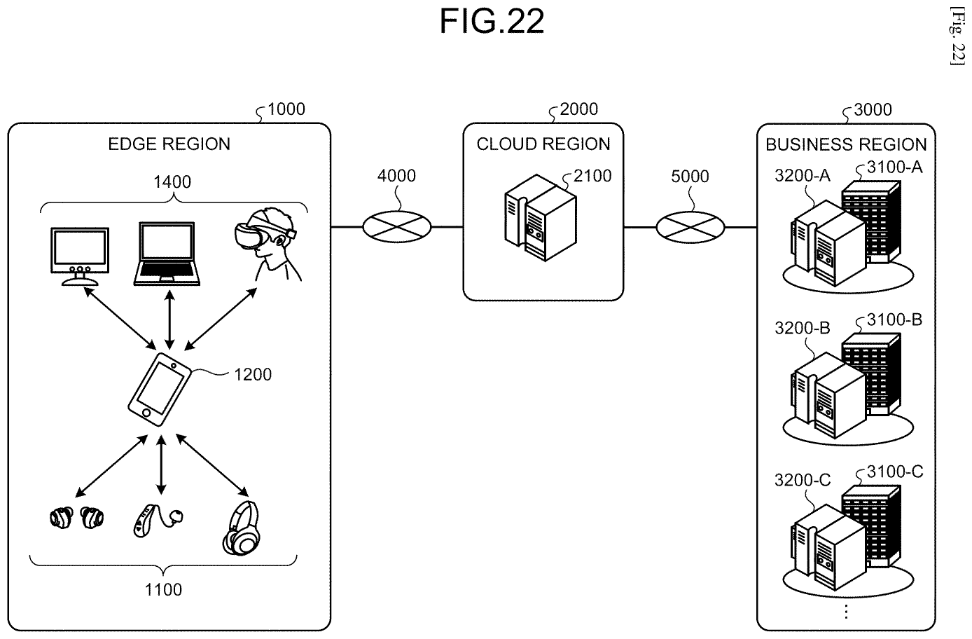

In the edge region 1000, for example, the sound producing device 1100 may cooperate with another device using the peripheral device 1200 such as a smartphone as a hub. An example will be described with reference to FIG. 22.

FIG. 22 is a diagram illustrating an example of cooperation with other devices. The edge region 1000, the cloud region 2000, and the business region 3000 are connected by a network 4000 and a network 5000. An example of the peripheral device 1200 in the edge region 1000 is a smartphone, and examples of elements in the edge region 1000 include other devices 1400. Note that illustration of the mobile body 1300 (FIG. 20) is omitted.

The peripheral device 1200 can communicate with each of the sound producing device 1100 and the other devices 1400. The communication method is not particularly limited, but for example, Bluetooth LDAC, Bluetooth LE Audio described above, or the like may be used. Communication between the peripheral device 1200 and the other device 1400 may be multicast communication. An example of the multicast communication is Auracast (registered trademark) or the like.

The other device 1400 is used in cooperation with the sound producing device 1100 via the peripheral device 1200. Specific examples of the other device 1400 include a television, a personal computer, and a head mounted display (HMD), and the like.

Even in a case where the sound producing device 1100, the peripheral device 1200, and the other device 1400 satisfy a specific condition (for example, a condition that at least a part thereof is provided by the same business operator), the incentive may be provided to the user.

The sound producing device 1100 and the other device 1400 can cooperate with the peripheral device 1200 as a hub. The cooperation may be performed using various data stored in the server device 2100 in the cloud region 2000. For example, information such as fitting data, viewing time, and hearing of the user is shared between the sound producing device 1100 and the other device 1400, whereby volume adjustment and the like of each device are performed in cooperation. Setting for a hearing aid (HA) or a sound collector (personal sound amplification product (PSAP)) can be automatically performed on a television, a PC, or the like when the HA or the PSAP is worn. For example, when the user who uses HA uses another device such as a television or a PC, processing of automatically changing the setting of the another device may be performed so that a setting that is usually suitable for a listener with normal hearing becomes a setting suitable for the user who uses the HA. Note that whether or not the user is using HA may be determined by automatically sending information indicating that the user wears the HA (for example, wearing detection information) to a device such as a television, a PC, or the like as a pairing destination of HA when the user wears the HA, or may be detected by using approach of the user using HA to another device such as a target television, PC, or the like as a trigger. Furthermore, by imaging the face of the user with a camera or the like provided in another device such as a television, a PC, or the like, it may be determined that the user is an HA user, or it may be determined by a method other than the above-described method. The earphone can also function as a hearing aid. A hearing aid can also be used in a style as if listening to music (action, appearance, or the like). The earphones or headphones and the hearing aid have many technically overlapping parts, and it is assumed that the barrier between the earphones or headphones and the hearing aid disappears in the future and one device has functions of both the earphone and the hearing aid. When hearing is normal, that is, a listener with normal hearing can enjoy the content viewing experience by using it as normal earphones or headphones, and when hearing is lowered due to aging or the like, the function as a hearing aid can be fulfilled by turning on the hearing aid function. Since the device as an earphone can be used as it is as a hearing aid, continuous and long-term use by the user can be expected also from the viewpoint of appearance and design.

Data of the user's listening history may be shared. Prolonged listening can be a risk for future hearing loss. Notification or the like to the user may be performed so that the listening time does not become too long. For example, when the viewing time exceeds a predetermined threshold value, such a notification is made (safe listening). The notification may be performed by any device in the edge region 1000.

At least a part of the devices used in the edge region 1000 may be provided by a different business operator. Information regarding device settings and the like of each business operator may be transmitted from the server device 3200 in the business region 3000 to the server device 2100 in the cloud region 2000 and stored in the server device 2100. By using such information, it is also possible to cooperate between devices provided by different business operators.

### 12. Example of Application Transition

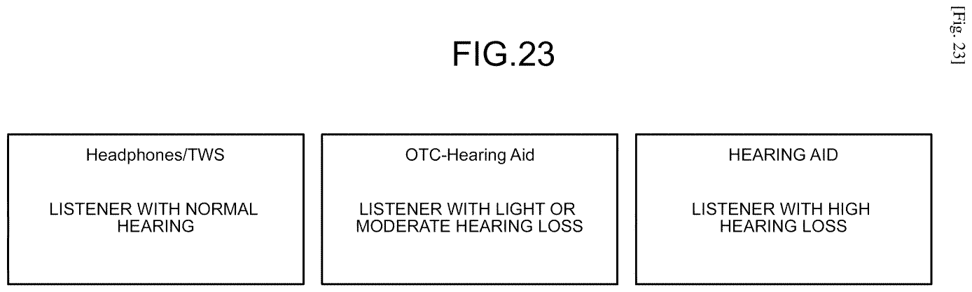

The application of the sound producing device 1100 may transition according to various situations including the fitting data of the user, the viewing time, the hearing ability, and the like as described above. An example will be described with reference to FIG. 23.

FIG. 23 is a diagram illustrating an example of application transition. When the user is a listener with normal hearing, for example, while the user is a child and for a while after becoming an adult, the sound producing device 1100 is used as headphones or earphones (headphones/TWS). In addition to the safe listening described above, adjustment of the equalizer, processing according to the user's behavior characteristic, current location, and external environment (for example, it is switched to an optimal noise canceling mode for a scene in which the user is at a restaurant and a scene in which the user is on a vehicle), collection of a listened music log, and the like are performed. Communication between devices using Auracast is also used.

As the user's hearing declines, the hearing aid function of the sound producing device 1100 begins to be utilized. For example, while the user is with light or moderate hearing loss, the sound producing device 1100 is used as an over the counter hearing aid (OTC hearing aid). When the user is with high hearing loss, the sound producing device 1100 is used as a hearing aid. Note that the OTC hearing aid is a hearing aid that is sold at a store without going through an expert, and has the ease of purchase without going through an expert such as a hearing test or an audiologist. A specific operation of the hearing aid such as fitting may be performed by the user himself/herself. While the sound producing device 1100 is used as an OCT hearing aid or a hearing aid, hearing measurement is performed or a hearing aid function is turned on. For example, a function such as transmission of an utterance flag in the above-described embodiment can also be used. Furthermore, various types of information regarding hearing (hearing big data) are collected, fitting, sound environment adaptation, remote support, and the like are performed, and a transcription is performed.

### 13. Example Effects

The technology described above is specified as follows, for example. One of the disclosed technologies is a hearing aid device 4 (an example of an information processing device). As described with reference to FIGS. 1 to 15 and the like, the hearing aid device 4 is used by being worn by the user U1. The hearing aid device 4 includes an output unit 47 that outputs a sound in which the voice V1 of the user U1 is suppressed from the ambient sound AS including the voice V1 of the user U1 and the voice of the user U2 (second user) different from the user U1 (for example, the voice V2 of the user U2) on the basis of the detection result (detection result of the utterance detecting unit 44) from detection of the utterance of the user U1 (first user). Thus, it is possible to suppress the voice V1 of the user U1 output by the hearing aid device 4.

As described with reference to FIG. 2 and the like, the hearing aid device 4 includes the sensor 43 used to detect the utterance of the user U1, and the sensor 43 may include at least one of an acceleration sensor, a bone conduction sensor, or a biological sensor. For example, by using such a sensor 43, the utterance of the user U1 can be detected.

As described with reference to FIGS. 2 to 4 and the like, the detection result from the detection of the utterance of the user U1 may include the utterance section of the user U1. The detection result from the detection of the utterance of the user U1 may include a VAD signal S (detection signal) indicating one of the presence and absence of the utterance of the user U1 at a high level and the other at a low level. For example, it is possible to suppress the voice V1 of the user U1 from the ambient sound AS on the basis of such a detection result of the utterance detecting unit 44.

As described with reference to FIGS. 2, 5, and the like, the suppression of the voice V1 of the user U1 may include reducing the volume of the voice included in the ambient sound AS by the utterance section of the user U1. For example, the voice V1 of the user U1 can be suppressed from the ambient sound AS in this manner.

As described with reference to FIGS. 6 to 8 and the like, the suppression of the voice V1 of the user U1 may include separating the voice V1 of the user U1 and the voice of the user U2 and the like (for example, the voice V2 and the voice V3) included in the ambient sound AS, and suppressing the voice V1 of the user U1 out of the voice V1 of the user U1 and the voice of the user U2 and the like which have been separated. Thus, the voice V1 of the user U1 can be reliably suppressed without suppressing the voice of the user U2 and the like. For example, a plurality of voices included in the ambient sound AS may be separated, and a voice having an utterance section corresponding to the utterance section of the user U1 (that is, the voice V1) may be suppressed among the plurality of separated voices. More specifically, the VAD signal (for example, VAD signal Sa, VAD signal Sb, and VAD signal Sc) of each of the plurality of separated voices may be generated, and among the plurality of separated voices, a voice whose VAD signal is closest to the VAD signal S included in the detection result from the detection of the utterance of the user U1 (that is, the voice V1) may be suppressed. As an example, the correlation value C (for example, the correlation value Ca, the correlation value Cb, and the correlation value Cc) between the generated VAD signal of each of the plurality of voices and the VAD signal S included in the detection result from the detection of the utterance of the user U1 may be calculated, and a voice having the largest calculated correlation value C (that is, the voice V1) among the plurality of voices may be suppressed. For example, in this manner, it is possible to reliably suppress only the voice V1 of the user U1 among the voice V1 of the user U1, the voice of the user U2, and the like.

As described with reference to FIGS. 2, 5, 6, 9 to 11, 14, and the like, the Hearing aid device 4 may include the utterance detecting unit 44 that detects the utterance of the user U1. Thus, it is possible to suppress the voice V1 of the user U1 output by the utterance detecting unit 44 on the basis of the utterance of the user U1 detected by the hearing aid device 4.

As described with reference to FIGS. 2, 5, 6, 14, 15, and the like, the hearing aid device 4 may include the wireless reception unit 41 that receives the ambient sound AS collected by the external terminal 2 and at least partially wirelessly transmitted. Thus, for example, a part of the processing can be borne by the external terminal 2, and the processing burden on the hearing aid device 4 can be reduced. The problem caused by the delay of the wireless communication between the external terminal 2 and the hearing aid device 4, for example, the problem that the user U1 hears his/her voice V1 doubly or mixed with the voice V2 of the user U2 can be handled by suppressing the voice V1 of the user U1.

The method described with reference to FIGS. 1 to 16 and the like is also one of the disclosed technologies. The method includes that the hearing aid device 4 (an example of the information processing device) worn and used by the user U1 outputs a sound in which the voice V1 of the user U1 is suppressed from the ambient sound AS including the voice V1 of the user U1 and the voice of the user U2 different from the user U1 (for example, the voice V2 of the user U2) on the basis of the detection result from the detection of the utterance of the user U1 (step S3). Also by such a method, it is possible to suppress the voice V1 of the user U1 output by the hearing aid device 4.

The program 931 described with reference to FIGS. 1 to 17 and the like is also one of the disclosed techniques. The program 931 causes the computer 9 worn and used by the user U1 to execute processing of outputting a sound in which the voice V1 of the user U1 is suppressed from the ambient sound AS including the voice V1 of the user U1 and the voice of the user U2 different from the user U1 (for example, the voice V2 of the user U2) on the basis of the detection result from the detection of the utterance of the user U1. Such a program 931 can also suppress the voice V1 of the user U1 output by the hearing aid device 4.

The system 1 described with reference to FIGS. 1 to 8, FIGS. 12 to 15, and the like is also one of the disclosed technologies. The system 1 includes the hearing aid device 4 (an example of the information processing device) worn and used by the user U1, and the external terminal 2 wirelessly communicating with the hearing aid device 4. The external terminal 2 collects the ambient sound AS including the voice V1 of the user U1 and the voice of the user U2 or the like different from the user U1 (for example, the voice V2 and the voice V3), and wirelessly transmits at least a part (for example, the voice V2 and the voice V3) of the collected ambient sound to the hearing aid device 4. The hearing aid device 4 outputs a sound in which the voice V1 of the user U1 is suppressed from the ambient sound AS on the basis of the detection result from the detection of the utterance of the user U1. Such a system 1 can also suppress the voice V1 of the user U1 output by the hearing aid device 4.

As described with reference to FIGS. 6 to 8 and the like, the hearing aid device 4 may wirelessly transmit the detection result (for example, the VAD signal S) from the detection of the utterance of the user U1 to the external terminal 2, and the external terminal 2 may separate the voice V1 of the user U1 and the voice of the user U2 and the like different from the user U1 (for example, the voice V2 and the voice V3) included in the ambient sound AS, and suppress the voice V1 of the user U1 out of the voice V1 of the user U1 and the voice of the user U2 and the like which have been separated. As described above, the external terminal 2 suppresses the voice V1 of the user U1, so that the processing load of the hearing aid device 4 can be reduced. For example, the external terminal 2 may suppress a voice having an utterance section corresponding to the utterance section of the user U1 (that is, the voice V1) among the plurality of separated voices. More specifically, the external terminal 2 may generate the VAD signal (detection signals, for example, VAD signal Sa, VAD signal Sb, and VAD signal Sc) of each of the plurality of separated voices, and suppress, from among the plurality of separated voices, a voice whose VAD signal is closest to the VAD signal S included in the detection result from the detection of the utterance of the user U1 in the hearing aid device 4 (that is, the voice V1). As an example, the external terminal 2 may calculate the correlation value C (for example, the correlation value Ca, the correlation value Cb, and the correlation value Cc) between the generated VAD signal of each of the plurality of voices and the VAD signal S included in the detection result from the detection of the utterance of the user U1 in the hearing aid device 4, and suppress the voice having the largest calculated correlation value C (that is, the voice V1) among the plurality of voices. For example, in this manner, it is possible to reliably suppress only the voice V1 of the user U1 among the voice V1 of the user U1, the voice of the user U2, and the like.

As described with reference to FIG. 15 and the like, the external terminal 2 includes the sensor 32 (including, for example, a camera) used to detect the utterance of the user U1, and the external terminal 2 may execute the processing of suppressing the voice V1 of the user U1 (turn on the processing of the speaker separation processing block B) when the utterance of the user U1 is detected using the sensor 32, and may not execute the processing of suppressing the voice V1 of the user U1 (turn off the processing of the speaker separation processing block B) otherwise. Thus, the processing load on the external terminal 2 can be reduced and the power consumption can be reduced.

Note that the effects described in the present disclosure are merely examples and are not limited to the disclosed contents. There may be other effects.

Although the embodiments of the present disclosure have been described above, the technical scope of the present disclosure is not limited to the above-described embodiments as it is, and various modifications can be made without departing from the gist of the present disclosure. Furthermore, components of different embodiments and modification examples may be appropriately combined.

Note that the present technology can also have the following configurations.
(1) An information processing device worn and used by a first user, the information processing device comprising:
   an output unit that outputs a sound in which a voice of the first user is suppressed from an ambient sound including the voice of the first user and a voice of a second user different from the first user on a basis of a detection result from detection of an utterance of the first user.
(2) The information processing device according to (1), further comprising
   a sensor used to detect an utterance of the first user, wherein
   the sensor includes at least one of an acceleration sensor, a bone conduction sensor, or a biological sensor.
(3) The information processing device according to (1) or (2), wherein
   the detection result from the detection of the utterance of the first user includes an utterance section of the first user.
(4) The information processing device according to any one of (1) to (3), wherein the detection result from the detection of the utterance of the first user includes a detection signal indicating, at a high level, one of presence and absence of the utterance of the first user and indicating the other at a low level.
(5) The information processing device according to any one of (1) to (4), wherein the suppression of the voice of the first user includes reducing a volume of a voice included in the ambient sound only for an utterance section of the first user.
(6) The information processing device according to any one of (1) to (4), wherein the suppression of the voice of the first user includes separating the voice of the first user and the voice of the second user included in the ambient sound, and suppressing the voice of the first user between the voice of the first user and the voice of the second user which have been separated.
(7) The information processing device according to (6), wherein
   the detection result from the detection of the utterance of the first user includes an utterance section of the first user, and
   the suppression of the voice of the first user includes separating a plurality of voices included in the ambient sound, and suppressing a voice having an utterance section corresponding to the utterance section of the first user among the plurality of separated voices.
(8) The information processing device according to (7), wherein
   the detection result from the detection of the utterance of the first user includes a detection signal indicating, at a high level, one of presence and absence of the utterance of the first user and indicating the other at a low level, and
   the suppression of the voice of the first user includes separating a plurality of voices included in the ambient sound, generating a detection signal of each of the plurality of separated voices, and suppressing, among the plurality of separated voices, a voice whose detection signal is closest to the detection signal included in the detection result from the detection of the utterance of the first user.
(9) The information processing device according to (8), wherein
   the suppression of the voice of the first user includes calculating a correlation value between the generated detection signal of each of the plurality of voices and the detection signal included in the detection result from the detection of the utterance of the first user, and suppressing a voice having a largest calculated correlation value among the plurality of voices.
(10) The information processing device according to any one of (1) to (9), further comprising
   an utterance detecting unit that detects an utterance of the first user.
(11) The information processing device according to any one of (1) to (10), further comprising
   a wireless reception unit that receives the ambient sound collected by an external terminal and at least partially wirelessly transmitted.
(12) A method comprising:
   outputting, by an information processing device worn and used by a first user, a sound in which a voice of the first user is suppressed from an ambient sound including the voice of the first user and a voice of a second user different from the first user on a basis of a detection result from detection of an utterance of the first user.
(13) A program for causing a computer worn and used by a first user to execute:
   a process of outputting a sound in which a voice of the first user is suppressed from an ambient sound including the voice of the first user and a voice of a second user different from the first user on a basis of a detection result from detection of an utterance of the first user.
(14) A system comprising:
   an information processing device worn and used by a first user; and
an external terminal that wirelessly communicates with the information processing device, wherein
   the external terminal collects an ambient sound including a voice of the first user and a voice of a second user different from the first user, and wirelessly transmits at least a part of the collected ambient sound to the information processing device, and
   the information processing device outputs a sound in which the voice of the first user is suppressed from the ambient sound on a basis of a detection result from detection of an utterance of the first user.
(15) The system according to (14), wherein
   the information processing device detects the utterance of the first user and wirelessly transmits the detection result from the detection of the utterance of the first user to the external terminal, and
   the external terminal separates the voice of the first user and the voice of the second user included in the ambient sound, and suppresses the voice of the first user between the voice of the first user and the voice of the second user which have been separated.
(16) The system according to (15), wherein
   the detection result from the detection of the utterance of the first user includes an utterance section of the first user, and
   the external terminal separates a plurality of voices included in the ambient sound, and suppresses a voice having an utterance section corresponding to the utterance section of the first user among the plurality of separated voices.
(17) The system according to (16), wherein
   the detection result from the detection of the utterance of the first user includes a detection signal indicating, at a high level, one of presence and absence of the utterance of the first user and indicating the other at a low level, and
   the external terminal separates a plurality of voices included in the ambient sound, generates a detection signal of each of the plurality of separated voices, and suppresses, among the plurality of separated voices, a voice whose detection signal is closest to the detection signal included in the detection result from the detection of the utterance of the first user in the information processing device.
(18) The system according to (17), wherein
   the external terminal calculates a correlation value between the generated detection signal of each of the plurality of voices and the detection signal included in the detection result from the detection of the utterance of the first user in the information processing device, and suppresses a voice having a largest calculated correlation value among the plurality of voices.
(19) The system according to any one of (14) to (18), wherein
   the external terminal includes a sensor used to detect an utterance of the first user, and
   the external terminal executes processing of suppressing the voice of the first user when the utterance of the first user is detected by using the sensor, and does not execute the processing of suppressing the voice of the first user when the utterance of the first user is not detected.
(20) The system according to (19), wherein
   the sensor includes a camera.

### REFERENCE SIGNS LIST

1 System
2 External terminal (information processing device)
21 Sound collection unit
22 Noise suppression unit
23 Wireless transmission unit
24 Sound separation unit
25 VAD signal generating unit
26 Wireless reception unit
27 Own sound component determining unit
271 Correlation value calculation unit
271a Correlation value calculation unit
271b Correlation value calculation unit
271c Correlation value calculation unit
272 Comparison and determining unit
28 Volume adjusting unit
28a Volume adjusting unit
28b Volume adjusting unit
28c Volume adjusting unit
29 Mixer unit
30 Wireless transmission unit
31 Wireless reception unit
32 Sensor
33 Device wearer utterance determining unit
34 Selection unit
4 Hearing aid device (information processing device)
41 Wireless reception unit
42 Volume adjusting unit
43 Sensor
44 Utterance detecting unit
45 Hearing aid processing unit
46 Volume adjusting unit
47 Output unit
48 Sound collection unit
49 Volume adjusting unit
49a Volume adjusting unit
49b Volume adjusting unit
50 Wireless transmission unit
51 Wireless transmission unit
52 Wireless reception unit
6 Server device (information processing device)
61 Wireless reception unit
62 Wireless transmission unit
9 Computer
91 Communication device
92 Display device
93 Storage device
931 Program
94 Memory
95 Processor
AS Ambient sound
B Speaker separation processing block
C Correlation value
Ca Correlation value
Cb Correlation value
Cc Correlation value
N Noise
S VAD signal
Sa VAD signal
Sb VAD signal
Sc VAD signal
U1 User
U2 User
V1 Voice
V2 Voice
V3 Voice

1. An information processing device worn and used by a first user, the information processing device comprising:
an output unit that outputs a sound in which a voice of the first user is suppressed from an ambient sound including the voice of the first user and a voice of a second user different from the first user on a basis of a detection result from detection of an utterance of the first user.

2. The information processing device according to claim 1, further comprising
a sensor used to detect an utterance of the first user, wherein
the sensor includes at least one of an acceleration sensor, a bone conduction sensor, or a biological sensor.

3. The information processing device according to claim 1, wherein
the detection result from the detection of the utterance of the first user includes an utterance section of the first user.

4. The information processing device according to claim 1, wherein
the detection result from the detection of the utterance of the first user includes a detection signal indicating, at a high level, one of presence and absence of the utterance of the first user and indicating the other at a low level.

5. The information processing device according to claim 1, wherein
the suppression of the voice of the first user includes reducing a volume of a voice included in the ambient sound only for an utterance section of the first user.

6. The information processing device according to claim 1, wherein
the suppression of the voice of the first user includes separating the voice of the first user and the voice of the second user included in the ambient sound, and suppressing the voice of the first user between the voice of the first user and the voice of the second user which have been separated.

7. The information processing device according to claim 6, wherein
the detection result from the detection of the utterance of the first user includes an utterance section of the first user, and
the suppression of the voice of the first user includes separating a plurality of voices included in the ambient sound, and suppressing a voice having an utterance section corresponding to the utterance section of the first user among the plurality of separated voices.

8. The information processing device according to claim 7, wherein
the detection result from the detection of the utterance of the first user includes a detection signal indicating, at a high level, one of presence and absence of the utterance of the first user and indicating the other at a low level, and
the suppression of the voice of the first user includes separating a plurality of voices included in the ambient sound, generating a detection signal of each of the plurality of separated voices, and suppressing, among the plurality of separated voices, a voice whose detection signal is closest to the detection signal included in the detection result from the detection of the utterance of the first user.

9. The information processing device according to claim 8, wherein
the suppression of the voice of the first user includes calculating a correlation value between the generated detection signal of each of the plurality of voices and the detection signal included in the detection result from the detection of the utterance of the first user, and suppressing a voice having a largest calculated correlation value among the plurality of voices.

10. The information processing device according to claim 1, further comprising
an utterance detecting unit that detects an utterance of the first user.

11. The information processing device according to claim 1, further comprising
a wireless reception unit that receives the ambient sound collected by an external terminal and at least partially wirelessly transmitted.

12. A method comprising:
outputting, by an information processing device worn and used by a first user, a sound in which a voice of the first user is suppressed from an ambient sound including the voice of the first user and a voice of a second user different from the first user on a basis of a detection result from detection of an utterance of the first user.

13. A program for causing a computer worn and used by a first user to execute:
a process of outputting a sound in which a voice of the first user is suppressed from an ambient sound including the voice of the first user and a voice of a second user different from the first user on a basis of a detection result from detection of an utterance of the first user.

14. A system comprising:
an information processing device worn and used by a first user; and
an external terminal that wirelessly communicates with the information processing device, wherein
the external terminal collects an ambient sound including a voice of the first user and a voice of a second user different from the first user, and wirelessly transmits at least a part of the collected ambient sound to the information processing device, and
the information processing device outputs a sound in which the voice of the first user is suppressed from the ambient sound on a basis of a detection result from detection of an utterance of the first user.

15. The system according to claim 14, wherein
the information processing device detects the utterance of the first user and wirelessly transmits the detection result from the detection of the utterance of the first user to the external terminal, and
the external terminal separates the voice of the first user and the voice of the second user included in the ambient sound, and suppresses the voice of the first user between the voice of the first user and the voice of the second user which have been separated.

16. The system according to claim 15, wherein
the detection result from the detection of the utterance of the first user includes an utterance section of the first user, and
the external terminal separates a plurality of voices included in the ambient sound, and suppresses a voice having an utterance section corresponding to the utterance section of the first user among the plurality of separated voices.

17. The system according to claim 16, wherein
the detection result from the detection of the utterance of the first user includes a detection signal indicating, at a high level, one of presence and absence of the utterance of the first user and indicating the other at a low level, and
the external terminal separates a plurality of voices included in the ambient sound, generates a detection signal of each of the plurality of separated voices, and suppresses, among the plurality of separated voices, a voice whose detection signal is closest to the detection signal included in the detection result from the detection of the utterance of the first user in the information processing device.

18. The system according to claim 17, wherein
the external terminal calculates a correlation value between the generated detection signal of each of the plurality of voices and the detection signal included in the detection result from the detection of the utterance of the first user in the information processing device, and suppresses a voice having a largest calculated correlation value among the plurality of voices.

19. The system according to claim 14, wherein
the external terminal includes a sensor used to detect an utterance of the first user, and
the external terminal executes processing of suppressing the voice of the first user when the utterance of the first user is detected by using the sensor, and does not execute the processing of suppressing the voice of the first user when the utterance of the first user is not detected.

20. The system according to claim 19, wherein
the sensor includes a camera.
